(19) United States
(12) Patent Application Publication
(10) Pub. No.: US 2006/0190616 A1
(43) Pub. Date: Aug. 24, 2006

(54) System and method for aggregating, delivering and sharing audio content

(76) Inventors: John Mayerhofer, Larkspur, CA (US); Peter Lee, Palo Alto, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/347,494

(22) Filed: Feb. 3, 2006

Related U.S. Application Data
(60) Provisional application No. 60/650,049, filed on Feb. 4, 2005.
(60) Provisional application No. 60/692,751, filed on Jun. 21, 2005.

(51) Int. Cl. G06F 15/16

(52) U.S. Cl. 709/231

(57) ABSTRACT

A digital audio content aggregation, delivery and sharing system and method are provided. The system and method delivers high-quality personalized digital audio directly to mobile handsets. In a preferred embodiment of the invention, the digital audio content may be podcasts. The system also provides a unique way to monetize audio content that benefits consumers, podcasters, mobile network operators, brands and advertisers. The system empowers a consumer to easily find, filter, store, organize, listen, and recommend audio content distributed across the Internet as podcasts. The system organizes the digital audio content by topic.

### RELATED APPLICATIONS/PRIORITY CLAIMS

This application claims priority under 35 USC 119(e) to U.S. Provisional Patent Application Ser. No. 60/650,049 filed on Feb. 4, 2005 entitled “Peer Based Media Infrastructure Platform” and U.S. Provisional Patent Application Ser. No. 60/692,751 filed on Jun. 21, 2005 entitled “Systems and Methods for Aggregating, Delivering and Sharing of Audio Content on Mobile Devices”, both of which are incorporated herein by reference.

### APPENDICES

Appendix A is a VoiceIndigo Data Aggregation Overview (1 pg.) that describes the system for aggregating digital audio content;

Appendix B is a Database Schema Design document (27 pgs.) that describes the database of the system and method for aggregating, delivering and sharing audio content;

Appendix C is a web services API (22 pgs.) for the system and method for aggregating, delivering and sharing audio content; and

Appendix D is a client reference document (19 pgs.) that describes the user interface for the client application as well as methods implemented on each client device.

All of these appendices form part of the specification of this patent application and are incorporated herein by reference.

### FIELD OF THE INVENTION

The invention relates generating to an audio content aggregation, delivery and sharing system.

### BACKGROUND OF THE INVENTION

Podcasting is a rapidly growing method of distributing audio files via the internet, enabling listeners to subscribe to programming of their choice, and then pull these files down to their local device for listening at their convenience. In essence, podcasts are listener demand driven, time-shifted, and place-shifted content.

Consumers now have unprecedented control over what they listen to, and when and where they listen to it. Podcasting is just about one year old, and already over 7 million Americans listen to podcasts. The number of listeners is growing exponentially and is expected to surpass network television in 4 years. Two days after Apple announced support for podcasting in iTunes, they had over 1 million podcast subscriptions.

Podcasters include both long-tail (niche) publishers such as GrapeRadio, ReelReviews, IT Conversations and brand name publishers such as the BBC, National Public Radio, ESPN, The Wall Street Journal, MSNBC, and ABC. The number of content producers distributing their work as podcasts is also growing exponentially. The Diffusion Group estimates that there will be over 1 million podcasters within the next 5 years.

Mobile handsets are evolving into the most natural device for the consumption of digital audio, such as podcasts. Thus, it is desirable to provide a system and method for permitting mobile handsets to download and play digital audio content such as podcasts. It is also desirable to provide a system and method for monetizing audio content that benefits consumers, podcasters, mobile network operators, and advertisers.

A conventional system exists that delivers advertisements to a device that has call functionality such as mobile phones wherein the system determines the appropriate characteristics of a mobile phone to which an advertisement is being delivered (screen size, processing power, etc) and then delivers an advertisement to the mobile phone that is customized to the characteristics of the particular mobile phone. However, the system does not contemplate delivering the advertisements with content, such as digital audio content, wherein the advertisements are matched to the digital audio content being delivered to the mobile phone. It is desirable to have a system that delivers advertisements to a mobile phone wherein the advertisements are matched to the digital audio content. Thus, it is desirable to provide a system method for aggregating, delivering and sharing audio content and it is to this end that the present invention is directed.

### SUMMARY OF THE INVENTION

A system and method for aggregating, delivering and sharing audio content is provided. The system and method delivers high-quality personalized digital audio directly to mobile handsets. In a preferred embodiment of the invention, the digital audio content may be podcasts. The system also provides a unique way to monetize audio content that benefits consumers, podcasters, mobile network operators, brands and advertisers. The system empowers a consumer to easily find, filter, store, organize, listen, and recommend audio content distributed across the Internet as podcasts. The system organizes the digital audio content by topic.

The system makes it simple for listeners to manage podcasts and access the podcasts through a variety of mobile devices. The system also enables digital audio content providers to connect with and better understand their audience and provide targeted advertising to their listeners.

Thus, in accordance with the invention, a podcast content aggregation, delivery and sharing system is provided that has one or more client devices and a podcast unit periodically coupled to the client devices over a communications path. The podcast unit has a storage unit containing a plurality of podcasts, an aggregating unit that gathers a podcast episode and stores it in the storage unit and a podcast management unit that manages the podcasts for users of the client devices based on a set of podcast preferences of each user. The podcast unit also has an advertisement unit that determines whether to place accompany the podcast with an advertisement for a podcast destined for a particular client device based on a set of statistics associated with the client device, a podcast delivery unit that is capable of delivering the podcasts contained in the storage unit and the advertisements accompanying the podcast for the particular client device to the particular client device based on the set of podcast preferences of the particular user of the client device using the communications path. Each client device is able to play the podcasts downloaded from the audio content unit.

### BRIEF DESCRIPTION OF THE DRAWINGS

FIG. 1 is a diagram illustrating a digital audio content aggregating, delivery and sharing system;

FIG. 2 is a diagram illustrating more details of the digital audio content aggregating, delivery and sharing system;

FIG. 3 illustrates an example of an implementation of the digital audio content aggregating, delivery and sharing system;

FIG. 4 illustrates an example of a transcoding server of the digital audio content aggregating, delivery and sharing system;

FIG. 5 illustrates an example of an advertisement and usage unit of the digital audio content aggregating, delivery and sharing system;

FIG. 6A-6E are diagrams illustrating examples of a method to mobilize the user in accordance with the invention;

FIG. 6F illustrates an example of an episode page with a download podcast link;

FIG. 7 illustrates an example of a mediajet browser of the digital audio content aggregating, delivery and sharing system;

FIGS. 8A-8D illustrate an example of a branded audio content aggregation, delivery and sharing system in accordance with the invention;

FIG. 9A is an example of a user interface for logging into the system;

FIG. 9B is an example of a user interface that lists podcasting channels once the user logs into the system

FIG. 10 is an example of a client device user interface for the postcasting channels;

FIG. 11 is an example of a user interface with an expanded channel with episodes;

FIG. 12 is an example of a user interface with channel subscriptions list;

FIG. 13 is an example of a user interface with channel preferences;

FIG. 14 is an example of a user interface for adding a podcast series to a channel;

FIG. 15 is an example of a user interface for publicly accessible channels;

FIG. 16 is an example of a user interface for user profile;

FIG. 17 is an example of a user interface for a client device when a user first starts the client application;

FIG. 18 is an example of a user interface for a client device when the user selects a channel from the user interface in FIG. 17;

FIG. 19 is an example of a user interface for a client device when the user selects a particular episode shown in FIG. 18;

FIG. 20 is an example of a user interface for a client device when the client device plays a piece of digital audio content;

FIG. 21 is an example of a user interface for a client device when the user selects call from the user interface shown in FIG. 20;

FIG. 22 is an example of a user interface for a client device when the user selects “Send Info” or “Request” from the user interface;

FIG. 23 is an example of a user interface for a client device when the user receives a confirmation message for the “Send Info” command;

FIG. 24 is an example of a user interface for a client device when the user is presented with a “click-to-buy” option;

FIG. 25 is an example of a user interface for a client device when the user bookmarks an advertisement;

FIG. 26 is an example of a user interface for a client device when the user recommends programs to other users;

FIG. 27 is an example of a recommend user interface for a client device;

FIG. 28 is an example of a user interface for a client device so that content providers connect with the user;

FIG. 29 is an example of a user interface for a client device to select how to connect with the content providers;

FIG. 30 is an example of a user interface for a client device when the user selects to send an email message to the content provider;

FIG. 31 is an example of a user interface for a podcaster section of the system;

FIG. 32 is an example of a user interface for a podcaster showing the details of each user that listens to the particular podcaster;

FIG. 33 is an example of a user interface for a revenue dashboard for a podcaster;

FIG. 34 is an example of a user interface for a ratings dashboard for a podcaster; and

FIG. 35 is an example of a user interface for a demographics dashboard for a podcaster.

### DETAILED DESCRIPTION OF A PREFERRED EMBODIMENT

The invention is particularly applicable to a system and method for aggregating, delivering and sharing podcasts (wherein the podcast may include audio or audio and video) and it is in this context that the invention will be described. It will be appreciated, however, that the system and method in accordance with the invention has greater utility since the system and method may be used with other types of digital audio content.

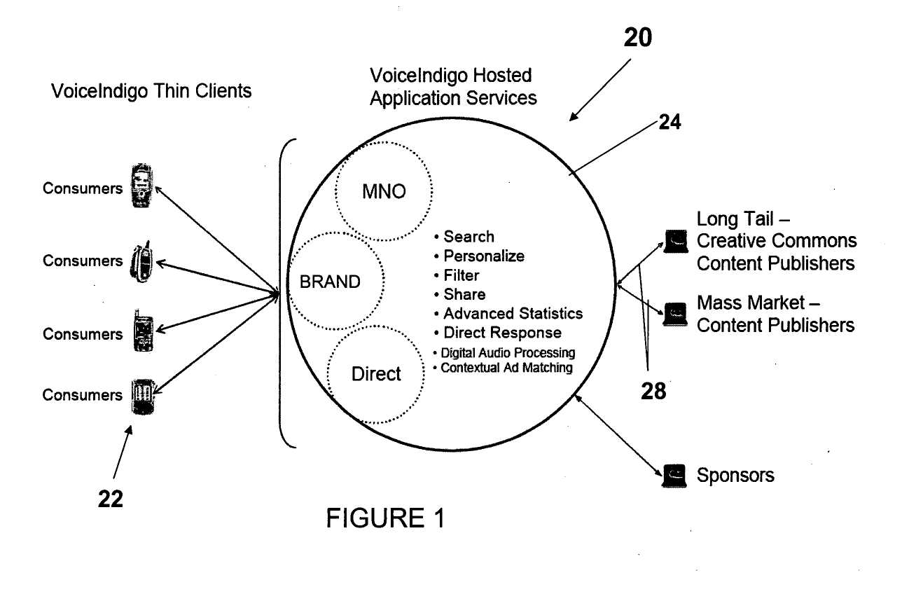

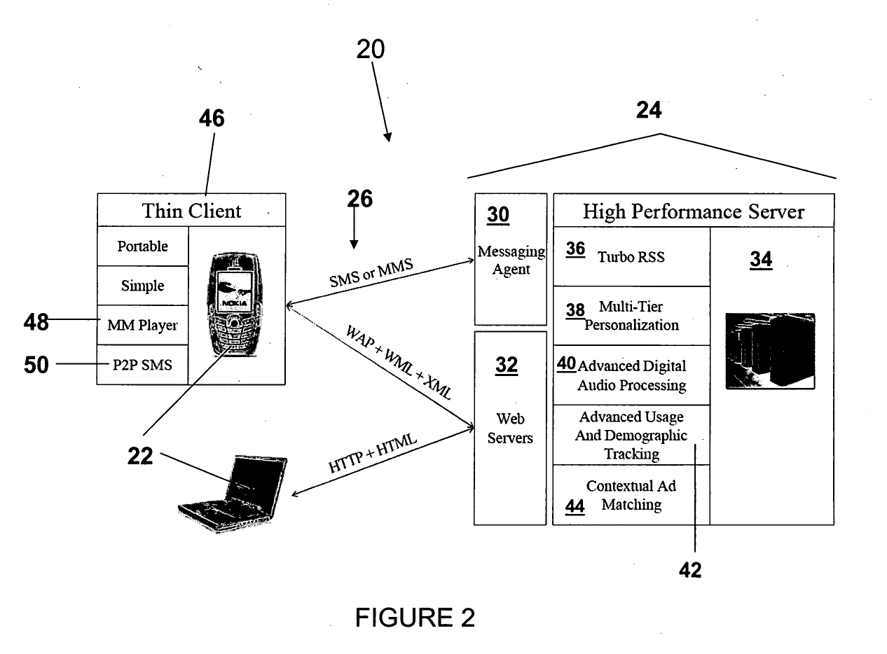

FIG. 1 is a diagram illustrating a digital audio content aggregating, delivery and sharing system 20. The system may include one or more client devices 22 that communicate with a digital audio content unit 24 over a communications path 26 (shown in more detail in FIG. 2). Each client device may be a processor-based device with sufficient processing power, particular display and audio capabilities and connectivity to be able to communicate with the digital audio content unit 24. For example, each client device may be a mobile phone, a PDA device, a wireless email device, a laptop computer, a personal computer, a tablet computer, a set-top box although the invention is not limited to any particular client device as long as the client device has the capabilities set forth above. For example, the client device may include a mobile phone that is able to receive audio content in only certain formats or a PDA with a small screen. The system is then able to assess the characteristics of the particular client device when it connects to the digital audio content unit 24 and send digital content that is customized to the particular characteristics of the particular client device. The communications path 26 may be a communications or data network, such as a GRPS network or wireless email network, capable of communicating data between each client device and the digital audio content unit 24. The communications path may also be a first client device that has access to the communications path and then a second client device that receives delivery of the digital content from the first client device. In a preferred embodiment, each client device is a mobile phone device with data capabilities, the digital audio content are podcasts and the digital audio content unit 24 may be a hosted system in which application services (an ASP model) are provided to the client devices. It is this embodiment of the system that is described below, although the system may be used to communicate other types of digital audio content between the client devices and the digital audio content unit 24 and the digital audio content unit 24 may be implemented using architectures other than the ASP model.

The digital audio content unit 24 may provide one or more services to each client device including digital audio content searching services, digital audio content personalization services, digital audio content filtering services, digital audio content sharing services, digital audio content statistics services (to a mobile network operator for example that manages the communications path 26 to the client devices), direct response services, digital audio processing services and contextual advertisement matching services. Each of these services provided by the digital audio content unit 24 is described in more detail below. The digital audio content unit 24 may also automatically collect data about public and proprietary audio content, provide storage by each user of the listening preferences of each user, provide storage for the contact information of their friends of the users (to permit sharing) and permit each advertiser to store their target audience information. The digital audio content unit 24 may also match user preferences with available audio content and then deliver that selected audio content to the user. The digital audio content unit 24 may also match the audio content in its storage against advertisement and then delivers those advertisement to the client devices that have been matched with the content. The content and advertisements are delivered to the client devices wirelessly. The digital audio content unit 24 may also convert the audio content into a client device appropriate format. The digital audio content unit 24 may also aggregate consumption data across the users for the audio content publishers. The web services API in Appendix C describes that data protocol between each client device and the digital audio content unit 24 to gather this consumption data.

Each client device may receive notifications from the digital audio content unit 24 wirelessly and poll the digital audio content unit 24 regularly. Each client device may also retrieve one or more content descriptions and one or more samples of the content (an audio thumbnail) to be able to sample the different content available on the digital audio content unit 24. A user may then select a particular piece of content from the digital audio content unit 24 that has been converted into the appropriate format as described below with respect to the transcoder server. The user of each client device may also recommend audio content to their friends store in the storage unit of the digital audio content unit 24 so that the audio content can be shared. The user may also view advertisements matched to the delivered audio content and respond to the advertisements directly from the client device as described below. Each client device also collects and summarizes audio content consumption data and communicates that information to the digital audio content unit 24 using the protocol set forth in Appendix C.

The system provides personalized digital media content. The system may be connected by a communications path/protocol 28, such as RSS, to various digital audio content providers such as mass market content publishers as well as creative content publishers. RSS is a family of eXtended Mark-up Language (XML) languages/protocols for web syndication and may include rich site summary (RSS 0.91), RDF site summary (RSS 0.9 and 1.0), really simply syndication (RSS2.0), ATOM or other protocols by which audio data may be communicated. The system may also be connected to one or more sponsors. The system may provide the services set forth above to mobile network operators (MNOs) to provide a low cost, rapid entry into the business of online media and advertising, a branded service and a direct to device service. The direct to device service allow users to find, filter, store, organize, listen and recommend audio content distributed across the Internet.

FIG. 2 is a diagram illustrating more details of the digital audio content aggregating, delivery and sharing system 20 wherein an exemplary client-server implementation of the system is shown. The client devices 22 shown are a typical mobile phone and a laptop computer, the digital audio content unit 24 comprises a messaging agent 30 that exchanges messages with the client devices, one or more web servers 32 that prepare and serve web page to the client devices and one or more high performance servers 34 that perform back-end processing of the system and the communications path 26 may include short message service (SMS) or multimedia message service (MMS) protocol messages between the messaging agent 30 and the mobile phone, wireless application protocol (WAP), wireless markup language (WML) and XML protocol messages between the mobile phone and the web servers 32 and hypertext transfer protocol (HTTP) or hypertext markup language (HTML) between the laptop computer and the web servers 32. The details of these messages are described in more detail in Appendix C.

The servers 34 of the digital audio content unit 24 may further comprise a Turbo RSS unit 36 that provides dynamic delivery of RSS feeds, which are read and delivered into personalized content lists stored in the unit 24 and then onto the client devices that has subscribed to the particular content list. The Turbo RSS unit 36 allows the unit 24 to gather the RSS feeds and aggregate them.

The servers 34 may further comprise a multi-tier personalization unit 38. The personalization unit permits each user of the system (with a particular client device) to personalize the digital audio content delivered to each user from the aggregated digital audio content stored on the digital audio content unit 24. In particular, during registration, each user may personalize the service when the user provides account information, mobile device(s) information, community information, advertising preferences and demographics information. The account information may include a unique username and password, an email address, a first and last name and a city, state and zip code of residence. The online (web-based) service from the system 20 may be used by users who don't use a mobile device to consumer audio content. For example, personalized subscriptions may be used as a RSS feed for other Podcast Aggregator applications (e.g. iPodder or even iTunes when they start supporting podcasts). A user may therefore register zero or more mobile devices wherein the mobile device(s) information may include the mobile carrier, the mobile phone number and the registered devices. The service permits users to recommend audio programming to a friend so that the community information may include a personal profile that may be private or public with public being the default and a choice of the method for communicating with friends that may be either email or SMS with email being the default. The advertising preferences may include direct response preferences, a method for providing more information to the user (email, snail mail, call me), quick buy payment information such as a credit card entry and shipping information. The demographics information may be information about the user such as household income, house ownership, job, etc. that may be used to customize the advertisement and/or audio content delivered to the user.

The system also permits the user to select one or more user customized programmed channels wherein each channel has the following options: a channel name, a channel description, a maximum audio program duration (in minutes with the default being 10), a number of programs to show on “My Channels” page wherein the default is 3, a number of programs to show on per page on “Channel Details” with the default being 10, the audio quality with the default being “as published”, privacy settings (Private, Public, Friends Only with the default being “Public”), and a podcast series subscription wherein each channel can contain one or more subscriptions to Podcast Series and the user may add Podcast Series subscriptions by (a) Browsing Directory, (b) Searching by keywords, or (c) Entering a RSS URL.

The system also permits each user to name other registered users, by their username, as their “friends” wherein friends can view and subscribe to one another's Personalized Channels. Establishing a “friendship” requires two-way commit, i.e. you name a friend, your friend gets a notification, your friend accepts, and the “friendship” is established. The system also permits each user to subscribe to any user's Public channels or the channels of a user's friends' Friends Only channels. Finally, the system may also provide “public” channels programmed by the system administrators wherein any registered user can subscribe to the channels.

The servers 34 may further comprise a digital audio processing unit 40 that processes the incoming digital content. For example, the unit 40 may reformat podcasts to a compressed audio format (per user preference) suitable for playback on mobile devices. The system may also insert bookmarks into the content for use by the system player described in more detail below.

The servers 34 may further comprise a usage and demographic tracking unit 42 that gathers information from each client device on the usage of the digital content. In particular, the unit 42 may gather consumption behavior data wherein the client application (on each client device) and online web site collects summary data on how much and how often a podcast is being listened to. The data collected by each client application is sent to unit 42 for aggregation. The data is communicated between the client device and the unit 42 using the protocols set forth in Appendix C. The aggregated information may then be provided to the content publishers as well as used to determine the appropriate advertising content for a particular piece of content. The usage data collected may include, for example, the number of audio programs on the device, a total number of seconds of audio programs on the device, a number of seconds of each audio programs (by ID) that has been listened and a total number of seconds of audio programs that have been listened to by the user.

Each client device 22 may have a client application 46 that is a plurality of lines of computer code (written in the appropriate format and language for the particular operating system or the particular client device) that is executed by a processor of the client device that performs various client functions of the system as described above. In addition to the client functions described above, the client application may include a multimedia player 48 that plays the digital content downloaded to the client device by the digital content unit 24 and a SMS application 50 that permits the client device to communicate with the messaging agent 30 of the digital content unit 24.

The client application 46 of each client device 22 and its user interface are further described in Appendix D which is incorporated herein by reference. For example, the client application may include a local storage management process that manages the space on the client device used by the content files. The details of this local storage management process is described in more detail in Appendix D.

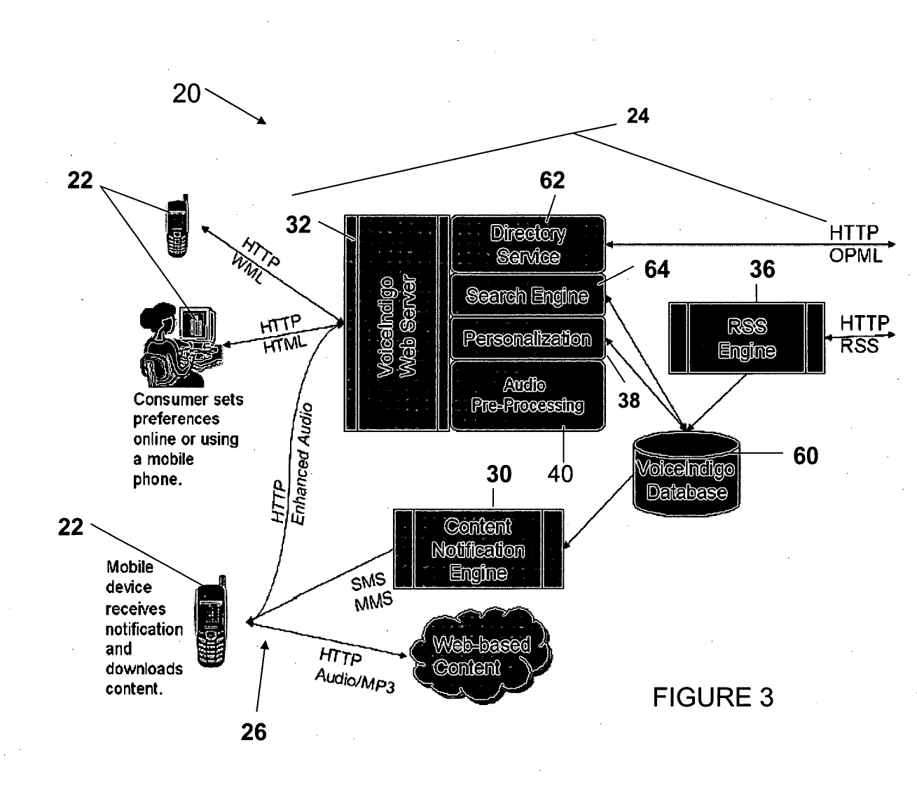

FIG. 3 illustrates an example of an implementation of the digital audio content aggregating, delivery and sharing system 20 that shows the details of the implementation details. In this implementation example, additional protocols/communications paths 26 are shown that are within the scope of the invention. As shown, a client device 22 registered with the system may request one or more pieces of content, based on preferences set by the user online or using a client device using HTTP and HTML protocols, using HTTP and WML protocols and may then receive the notifications and content using an HTTP, enhanced audio, SMS, MMS and/or audio/MP3 protocols wherein the content is delivered from the web server 32 or from web-based content as shown.

In addition to the units shown in FIG. 2, the digital content unit 24 may further comprise a data storage unit 60 that may preferably implemented as a database (the details of which are described in Appendix B which is part of this description) that stores the various data associated with the unit 24 including the content, the user information, the advertiser's information, the advertisements and the like. The system may further comprise a unit for validating the content. In particular, the system may provide a token to each publisher wherein the publisher embeds the token into its content (podcast) so that the podcast can be validated when it is downloaded to each client device.

The digital content unit 24 may also have a Podcast Box, or simply “Box,” for storing Podcast Episodes (also known as enclosures) for a user. The Box contains individual Podcast Episodes from the same or different RSS Feeds. For example, a Box can contain one Podcast Episode from Podcast Series A, and two Podcast Episodes from Podcast Series B. Podcast Series A and B can have other Podcast Episodes that are not part of this Box. The client devices see the Boxes of the unit 24 as Channels and present the user interface as if they are Channels. When the client device synchronizes with the server, the Podcast Episodes in the Box(es) are downloaded to the client device.

Two specific instances of Box, Inbox and ShareBox, are provided to each user users.

| Box Name | Type | Synchronize | Privacy |
|---|---|---|---|
| Inbox | In | Yes | Private, |
| | | | Friends or |
| | | | Public |
| ShareBox | Share | No | Friends, or |
| | | | Public |

The Inbox is a Box for the owner or other users (depending on Privacy Level setting) to drop in Podcast Episodes. The owner of an Inbox can drop Podcast Episodes to an Inbox. Users who are designated as “friends” of the owner can drop Podcast Episodes into user's Inbox if the Inbox's Privacy Level is set to Friends or Public. If an Inbox's Privacy Level is set to Public, then any user of the system can drop Podcast Episodes into the user's Inbox. An Inbox is usually synchronized with the client device, unless owner of an Inbox may change this setting to be not synchronized.

The ShareBox is a Box for the owner to share Podcast Episodes with other users of the system. Only the owner can drop Podcast Episodes into a ShareBox. If a ShareBox is designated as “Friends” Privacy Level, then only users named on the owner's friends list can access the Podcast Episodes in the ShareBox. If a ShareBox is designated as “Public”, then all users can access the Podcast Episodes in the ShareBox. Users with access to a ShareBox may subscribe to a ShareBox in the same way as one would subscribe to a Public Channel.

The digital content unit 24 may further comprise a directory service 62 that obtains RSS information from the internet and categorizes it into a hierarchical directory structure as outline processor markup language (OPML) protocol and a search engine 64 that permits the users, advertisers and the like to search for content that has been aggregated by the system.

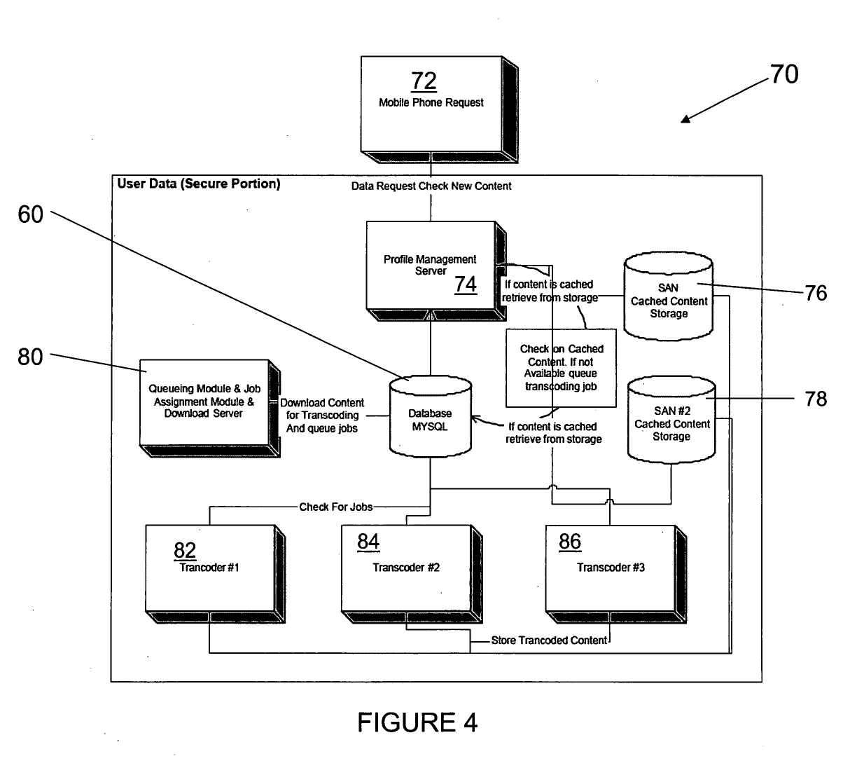

FIG. 4 illustrates an example of a transcoding server 70 of the digital audio content aggregating, delivery and sharing system that is part of the audio digital processor. The transcoding server permits users to access high quality audio content through a relatively low bandwidth network connection, such as a mobile phone network. To accomplish this, the transcoder server obtains content from a source and convert it to a file format that is more space efficient, e.g., wideband AMR, narrowband AMR or MP3 (usually at lower bit rates). The transcoder server provides better than real-time conversion of the input audio streams and serves the result back on the file system cache as well as record the file information and details in the data storage unit 60. The transcoding server 70 may also handle other types of content (e.g., video) that is can also convert into a format to deliver to the client devices.

The server 70 may receive a request for new content 72 that is received by a profile management server 74. The profile management server determines if the requested content is cached (i.e., already converted and stored in the system) and, if the content is cached, the content is retrieved from a cache system, such as a SAN cached content storage unit 76 and a second SAN cached content storage unit 78 and provide the content to the user. If the requested content is not cached, the transcoding of that content is queued (shown in the data storage 60) and then provided to a queuing module 80 that downloads the content for transcoding and queues the transcoding job. The server also have one or more transcoders, such as transcoder #1 82, transcoder #2 84 and transcoder #3 86, that checks for transcoding jobs, perform the transcoding job and then stores the transcoded content in the cache system.

In more detail, the queuing module 80 verifies that the requested media content has been fully downloaded and adds the job to the TrancodingJobs Table in the data storage unit 60. The various tables described in this section are described in more detail in Appendix B that contains an implementation of the database schema for the system. The queuing module also verifies the CompletedTranscodingJob Table in the data storage unit 60 for updating the Content/Cache Table in the data storage unit 60. The queuing module may further comprise a downloader module that starts downloading the audio stream into a stored folder on a storage server and, once completed, updates a Download table (in the data storage unit 60) to Complete and the server, filename, file type and directory information where the url is the same. The downloader module also checks on multiple requests with the same filename (URL) and it will replace it with a single request to the transcoder this will minimize the processing time used.

Each transcoder, as soon as it finishes a transcoding job, updates the CompletedTrancodingJob Table in the data storage unit 60 with the URL RequestID filetype (output) filename directory and server where the cached content is available. The transcoder then saves, on one of the SANs, the content of the transcoded file. After it has finished storing the completed job, it checks for a new job in the TrancodingJobs Table of the data storage unit 60 and will immediately start transcoding from the downloaded file wherein the information about the downloaded file is stored on the Download Table. The transcoder preferably handles MP3 input files only (since it the most prevalent type of podcast file), but can also handle other media file formats as necessary.

The server 70 may also have a logging and status reporting unit (not shown) that allows the status of the transcoder to be checked using a web-based status page. The status may include a number of files and number of bytes transcoded since last server reset (or since the beginning of the day today), an average bytes per second transcoded and/or whether or not the transcoder(s) are currently “idle” or transcoding a file. The software processes for media transcoding may also be implemented using a hardware-based accelerator plug-in card using technologies such as field programmable gate arrays (FPGAs). In the preferred implementation, the transcoder server is software-implemented and may run on Linux RedHat, Fedora Core 2 or above, or FreeBSD kernel 2.5 or above.

A Podcast show is usually assembled from multiple audio fragments, e.g. an introductory music, an abstract/teaser for the actual podcast, sponsorship message(s), special announcement(s), program, sponsorship message(s), trailers, credits. When a Podcast Show is published, these audio fragments are concatenated together to form one monolithic MP3 file. Therefore, the transcoding server 70 may also include a unit for disassembling a piece of content (a Podcast MP3 file) into its audio fragments according to textual disassembly instructions stored as part of the comments in the ID3 tag of the MP3 file headers. By disassembling a Podcast MP3 file into the audio fragments, the transcoding server 70 can do intelligent audio processing of the audio fragments and then reassemble the audio fragments back into a Podcast Show. For example, the system may replace an advertisement in the middle of a podcast due to the disassembly instructions. The system may also be used to disassemble video content and then reassemble video content.

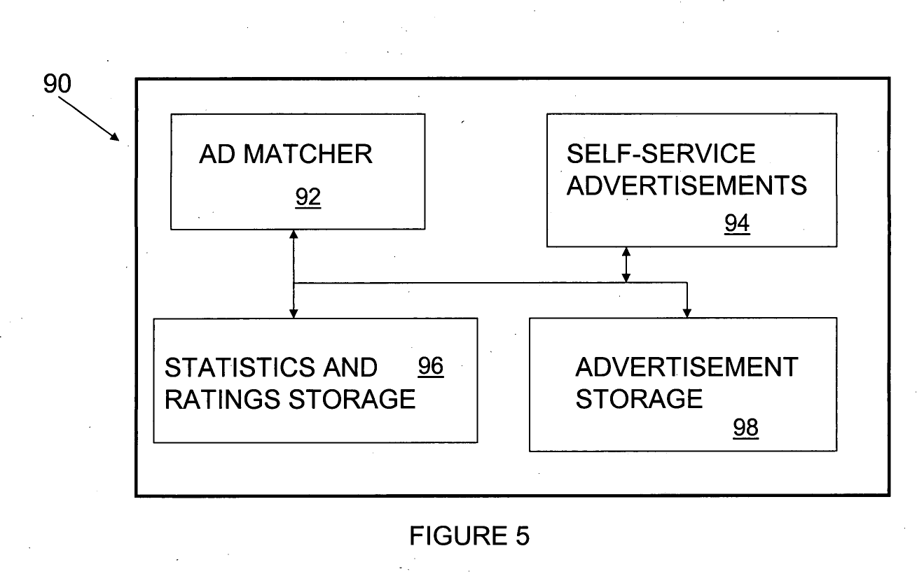

FIG. 5 illustrates an example of an advertisement and usage unit 90 of the digital audio content aggregating, delivery and sharing system. The unit may determine the appropriate advertisement to be delivered to each user based on the content being delivered, the user preferences and other data. The unit 90 may comprise an ad matcher unit 92 that performs the ad matching process and a self-service advertisement unit 94 that permits an advertiser to create and manage their ads and ad campaign on the system. The unit 90 may also include a statistic and rating storage 96 and advertisement storage 98 that store the statistics and usage information used by the ad unit 90 and the advertisements, respectively. For example, the usage information gathered by the ad unit 90 maybe provided to each digital content publisher. The details of the storage 96, 98 are further described in Appendix B.

As described above, the system downloads digital audio files to a user's client device that is executing a client application through which audio files can be played back. The client application on each client device logs the activities of the user that are then communicated to the digital content unit (and the ad unit) where the usage data is aggregated.

The usage data collected by captured the usage data when an event occurs. In particular, each successful audio file download is recorded as an event and each click of the Play and Stop/Pause button on the audio player user interface generates a listen event. Each event records the time of day of the event, the audio file being listened to, the starting offset (in seconds) into the audio file, and the duration of the audio listened. These records may be aggregated locally on the mobile handset. At the next synchronization step, aggregated events are formatted into an XML document describing all the listen events that are sent to the digital content unit 24. The unit 24 extracts the events from the uploaded usage data and aggregates it across all the relevant users of the system to create a usage summary that does not uniquely identify an individual.

The aggregated listened events can be reported per Podcast Series to inform Publisher of the Podcast Series of one or more of the following pieces of information:
Number of unique downloads
Number of unique listeners who listened to at least min seconds of a podcast from the Podcast Series. The number min is an adjustable parameter that defines the number of seconds that is a minimum threshold to consider a listen event from a user as to have actually listened to a podcast.
Average and Median number of seconds of each Podcast that has been listened to.
Average and Median percentage of each Podcast that has been listened to.
Explicit Ratings of podcasts from listeners.
Implicit Ratings (see below) of podcasts from listeners.

The explicit ratings are when a user takes an action (e.g. pressing a button on a listening device) to rate a podcast. The explicit ratings measure only users who decided to rate a show so that those ratings are less reliable because those who rate a show represent a self-selected group. The implicit ratings of a podcast are based on actual listening pattern. The method for using Podcast Listening Patterns for Implicit Rating is as follow:
Podcast description that was not viewed receives 0 point.
Percentage of podcast audio that has been listened:
   Podcast that was not listened to receives 0 point.
   Podcast that was listened to less than min % of the total time receives 1 point.
   Podcast that was listened to less than mid % of the total time receives 2 point.
   Podcast that was listened to greater than max % of the total time receives 3 points.
wherein min, mid and max are server parameters that can be set during data processing on the server.
   If any section of a podcast has been listened more than once, the podcast receives 1 additional point.
   If any section in the middle of a podcast has been skipped (user hitting fast forward), the podcast receives −0.5 point.
   If a podcast has been forwarded to a friend (via Share command in the client), the podcast receives 1 additional point.

The final rating of a podcast can be normalized to any point scale (1-10, 1-5, etc.). The algorithm for computing Implicit Rating can be changed without changing the listen events that has been collected.

The ad matcher 92 performs a process to match a particular advertisement with a particular piece of content for a particular user. Some of the details of the ad matching are based on the web services protocol contained in Appendix C. The tables in the database (See Appendix B for more details of the particular tables) used for the ad matching include AdListing and PublisherRSSFeed, an Advertiser table and a Campaign table. In typical advertising systems, an Advertiser creates a “campaign” for a product or a promotion so that the Advertiser table contains the various information about the Advertiser (or Ad Agency). Each ad campaign runs for a designated period of time (e.g. Jan. 1 to Jan. 31, 2006) and each campaign may have multiple creatives (i.e. AdListing entries). At any moment in time, only AdListing that are within an active campaign should be served.

For Ad Matching purposes, the system matches all RSSEnclosure table against the AdListing table when the system generates the ad placements during Poll. In reality, the system only has rights to place ads against certain content and the system obtains agreement from Podcasters to give us the right to place ads against their podcasts and such agreement is based on a RSSFeed rss_id. In other words, after Poll has obtained a list of Enclosures, it should only place ads against Enclosures belonging to RSSFeeds which we have the right to place ads on.

As an example, suppose Poll generated the following enc_id:

| Enc_id | rss_id |
|---|---|
| 1 | 1001 |
| 2 | 1001 |
| 3 | 1002 |
| 4 | 1002 |
| 5 | 1002 |
| 6 | 1003 |

The table PublisherRSSFeed table lists by publisher_id the rss_id that the system has the right to place ads against. So, if you look up PublisherRSSFeed table and find that we only have rights to place ads against rss_id 1001 and 1003, then only enc_id 1, 2 and 6 should have ads placed against them. Enc_id 3, 4 and 5 should not have ads.

The goal of Ad Matcher is to place the ads against these available impressions from the AdListings currently available in the system. The first match criteria is relevancy based on keywords and categorization of the podcast. Ad Placements should be based on content relevancy first because relevant ads are more useful to the end user and the user is more likely to respond (clickthru) to them. However, in the absence of highly relevant ads for an enclosure, we can place less relevant ads or may be even not relevant ads in the available inventory.

There are two ways of selling/pricing advertisements: (1) Impression Based, and (2) Performance Based. Impression based ad selling is priced in “CPM” (cost per thousand) so a CPM of $50 means that it costs the advertiser $50 to display the advertisement 1000 times (e.g, $0.05 per impression.) For performance based ads, the advertisers pay based on how many consumers responded to the ad (meaning how many consumes clicked through a particular ad) which is known as CPC (cost per click). The advertisements for the content system 20 are preferably priced at CPC so that advertisers pay based on number of times their ad is clicked on (from the client device.) The more times we display our ads, the more likely that it will get clicked on. So, the system presents advertisements whenever possible (i.e. if we have rights to display ads on an RSS feed). However, the system may also utilize impression-based CPM pricing.

The ad placements of the system should be based on the enclosure. The TagExtractor process operates at the Enclosure level so that the system uses the metadata associated with the enclosure (see fields in RSSItem table) first. If there's nothing useful in that table, the process resorts to the RSSFeedMetadata fields. However, given that enclosures within the same RSS Feed are likely to be about the same subject matter, it is possible that all enclosures with the rss have the same ad(s).

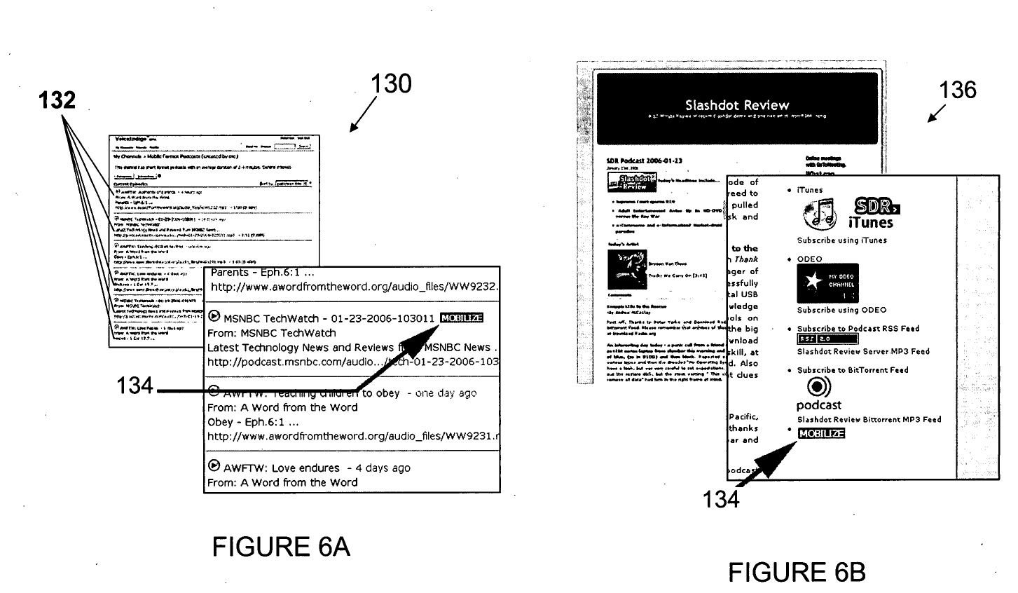

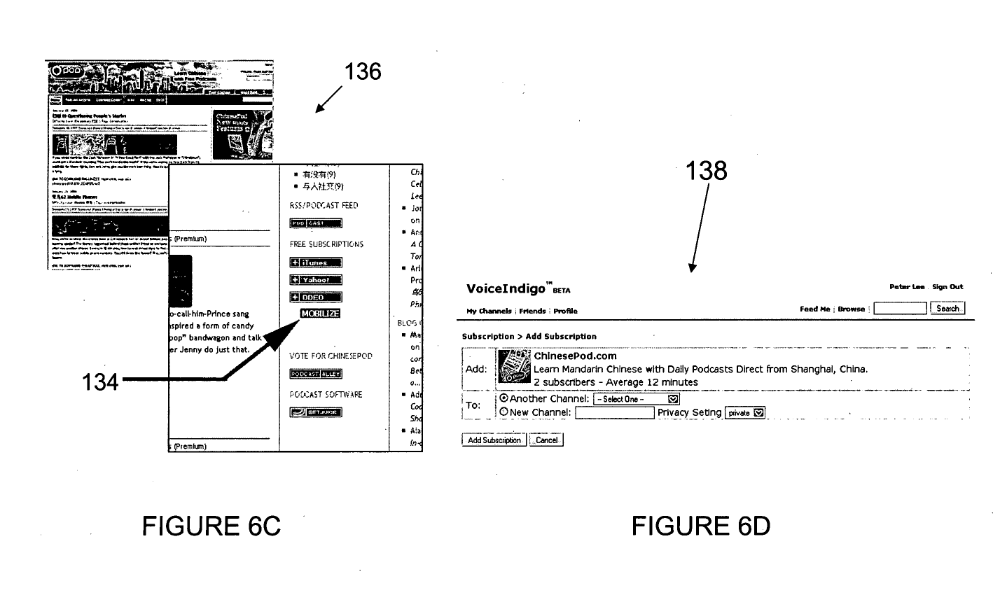

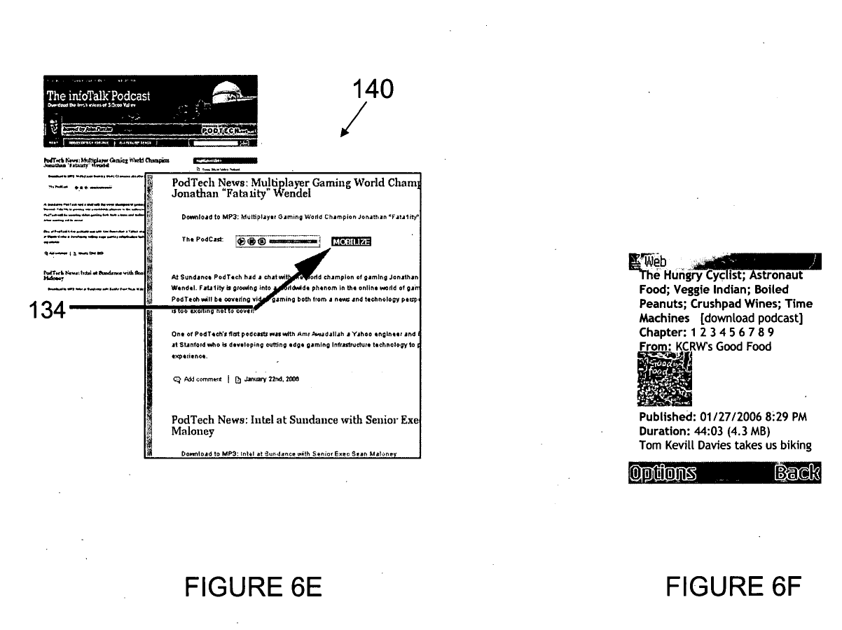

FIG. 6A-6E are diagrams illustrating examples of a method to mobilize the content requested by the user in accordance with the invention. In particular, on any web page (served from the web servers 32 of the unit 24) of the content system where a podcast episode is displayed, the system may provide a method to mobilize the content requested by the user. In particular, an exemplary web page 130 of the system having one or more podcast episodes 132 is shown in FIG. 6A wherein the method for mobilizing the user is placed onto the web page of the system. A close up of a podcast episode in the web page shows a “Mobilize” button 134 that may invoke a “Mobilize Me” process. In particular, a registered user of the system can click on the “Mobilize Me” button 134 to send a message (preferably an SMS message) to the user's registered client device so the content can be accessed later. When the user clicks on the link, the user is given a choice of playing this either via the WAP portal (wireless web page) or the client application of the client device, if they have a supported client device.

FIGS. 6B and 6C shown another example of a method for mobilizing the content requested by the user wherein the entry point is located on another website or a blog. On Blog and Podcaster web sites 136, the “Mobilize Me” link 134 takes readers of the blog directly to a quick login or registration page where the user can register for a free account on the digital audio content system 20. FIG. 6B shows an example of the mobilize button 134 on a Slashdot Review web page while FIG. 6C shows a ChinesePod web site. When user clicks on the mobilize link 134 for the other web pages, the user is taken to an Add Subscription page 138 shown in FIG. 6D of the digital audio content 24 web site if the user is already signed into the system. If user has not signed in yet, user will be prompted to sign in or register for a new account on the digital audio content system.

FIG. 6E shown an example of a web page 140 (PodTech) having the mobilize button 134 that is located next to a specific episode. In this example, the user can already hear the podcast on the PodTech's web site. The “Mobilize Me” button 134 lets the user hear this podcast on their mobile phone provided that the user is registered with the digital content audio system.

An example of a method for mobilizing the content requested by the user is described with reference to FIG. 6F. SMS (text messaging) and WAP Browser (mobile web browser) are the two most ubiquitous features on mobile phones today. Although the capability varies, the majority of mobile phones on the market today support some level of text messaging and mobile web. Users may also be more willing to try a service if it is available through the more affordable SMS messages and WAP Browser.

The system may provide both lite integration for features that can be implemented quickly and is intended for content sharing and recommendation and a complete integration that provides access to personalized content via a WAP Browser and access to search and browse via WAP Browser.

For the SMS integration, the client device may follow the following steps:

1. From VoiceIndigo web site, a “mobilize me” link appears on individual podcasts. Registered users who have signed in can click on this link to send a text message to their registered mobile phone. From the phone, click on the URL in the text message and a WAP Browser session is launched.

2. A “share me” link works in a way similar to “mobilize me” except that the text message is sent to a friend of the registered user. The “Share” command on VoiceIndigo Mobile allows the recommendation of podcasts via text messages.

3. The client application for the client device has a Share command that sends a SMS message (phone-to-phone SMS) with a URL to the podcast episode page as shown in FIG. 6F.

WAP Browser Access

Initially, only URLs sent by “mobilize me” or “share me” links need to be WAP Browser compatible. The episode page such as the example shown in FIG. 6F, may include:
Podcast Episode Title
Link(s) to audio media files.
Podcast Feed Title
Podcast Feed Image
Podcast Episode description and related data (e.g. duration, publication date, ratings, categories, etc.)

In the example in FIG. 6F, the page has a download podcast link that downloads the entire podcast. Due to file size limitations in the WAP Browser environments, multiple links may be provided for automatically generated 5-minute “chapters” of the audio file. For example, a 30-minute podcast may be broken up into 6 segments of approximately 5-minute chapters. User may access the segments one at a time. The links listed after Chapter allows user to download a 5-minute segment of the podcast.

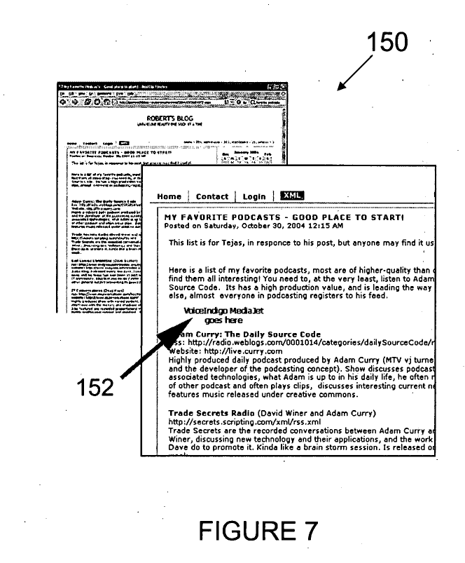

FIG. 7 illustrates an example of a mediajet browser web page 150 of the digital audio content aggregating, delivery and sharing system. The system 20 may provide a podcast media browser and player (preferably provided for free) at the location 152 that can be used by bloggers and podcasters. For the blogger website, the bloggers read, listen and watch other media and write about them. Most of the blogs today are text only. Textual blogs refer to other reports by quoting and linking to the original publication. It is not easy to seamlessly integrate published podcasts into the train of thoughts as presented in a blog without taking the readers attention to the podcast being referenced. An on-blog embedded media player at the location 152 serves that purpose.

For the podcasters, Podcasters either have to pay for an on-page player or rely on the listener having a MP3 player plug-in installed in their web browser. The digital audio content system provides this service to Podcasters who would like to have a free media player on their web site and can use it to play back audio podcasts cataloged on content Service.

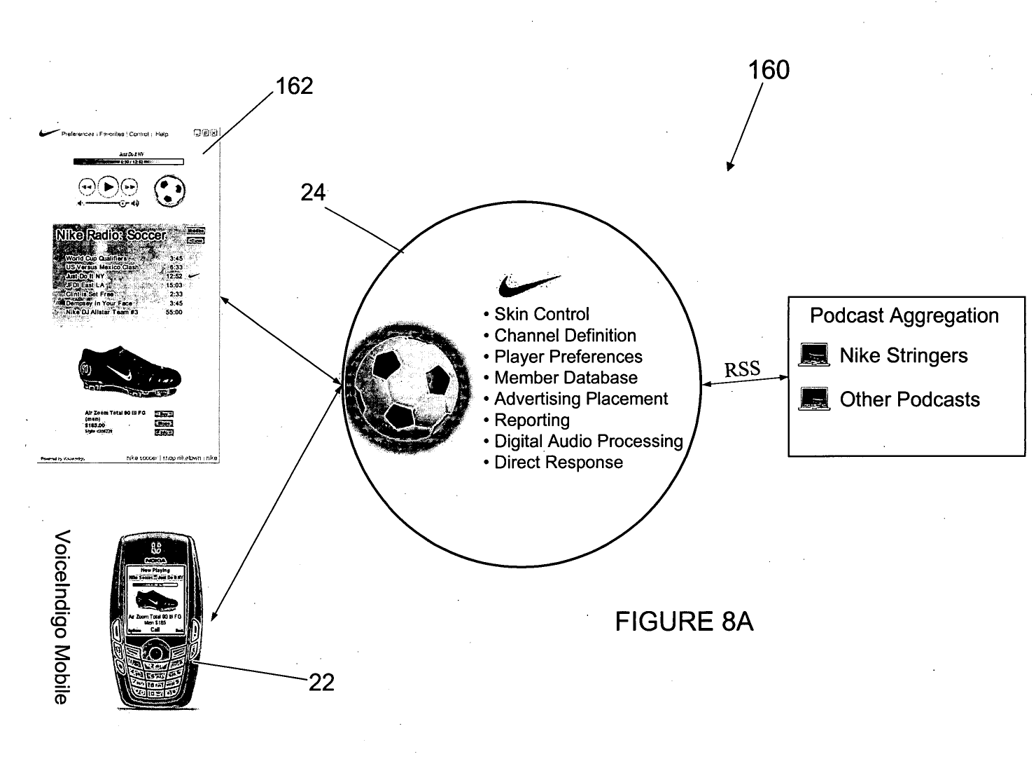

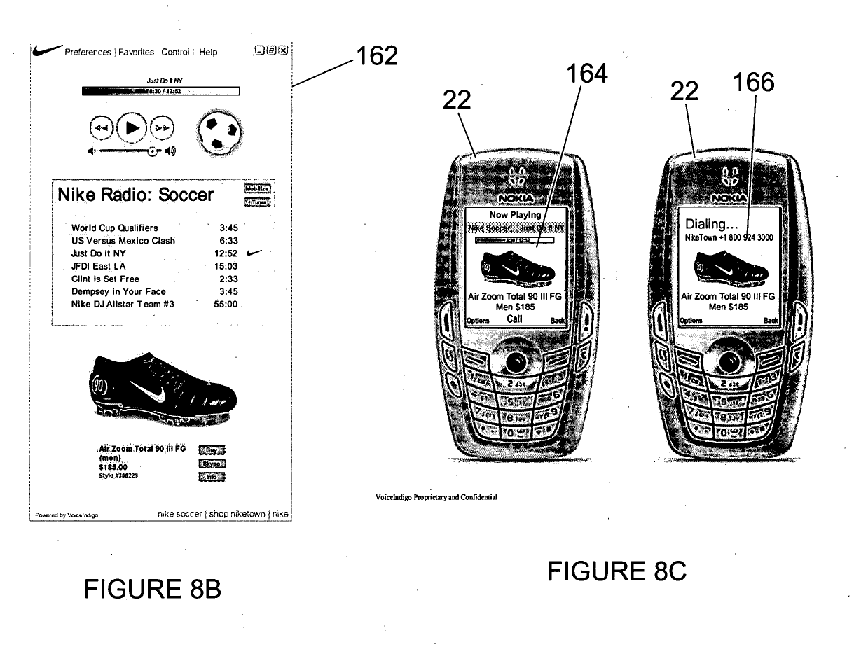

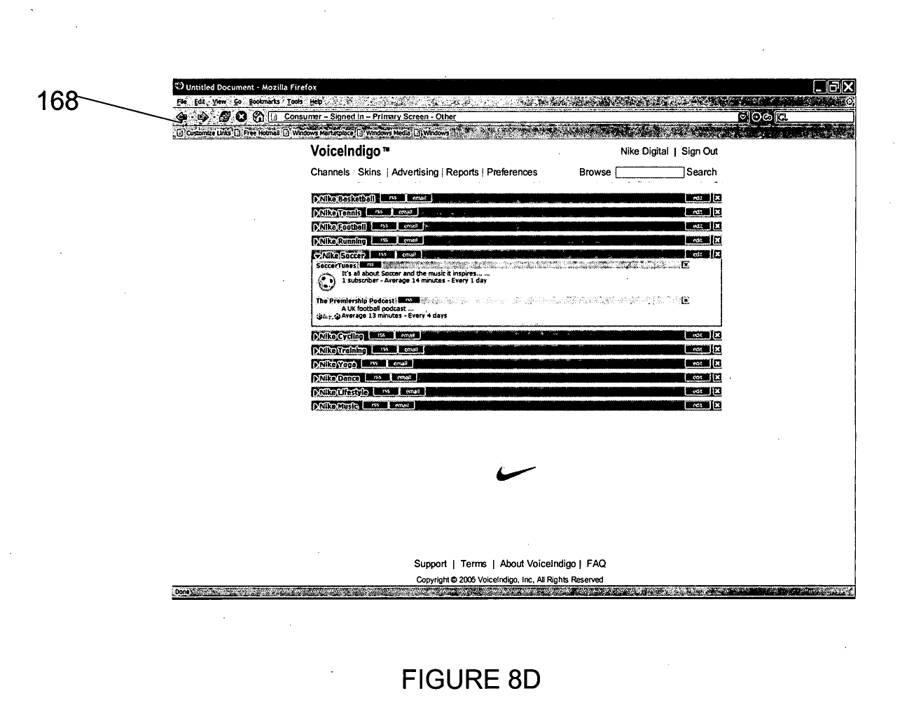

FIG. 8 shows an example of a blog website 150 with the link 152 wherein many bloggers list their favorite podcasts on their web sites. The digital audio content system provides these bloggers a place to assemble their podcast subscriptions and share it with their blog-readers. The system's MediaJet lets the bloggers go one step further by letting their blog-readers listen to the podcasts without even leaving the blog. Now, more details of the MediaJet media player of the system.

The MediaJet player may preferably be based on Macromedia Flash as the underlying delivery mechanism. The MediaJet player may be distributed as a small, easy to place, flexible Flash movie, configurable by an online administrative interface. The player configuration, player functionality, ambient advertising using the player and player usage tracking is now described.

The player configuration may include player startup, channel initialization, player branding security, scheduled content polling and player size. During player startup, after loading, the player configures itself by sending an identifying token to the digital content system server over an HTTP connection and receives in return the XML data defining its configuration from the Server. The configuration data affects the following aspects of the Player's appearance:
Button style and color—the look and feel of the buttons will be provided by arbitrary images, which will be overlaid with user-defined clickable regions (hotspots)—like an image map.
Player background—shows a solid user-defined color, plus the option to load one or more arbitrary images as additional background
Player Layout—user-configurable location of all controls, the Playlist, the progress bar, the main ad image, any additional images, the ad response buttons, and all clickable hotspots.
Channel List/Channel Id—a unique system id for the Channel

During the channel initialization, the Player automatically retrieves the Channel List by sending a User ID to the system servers over an HTTP connection and receiving in return the XML data defining that user's available Channels. The data may be a user's personalized channel configuration, or a player-specific channel specified by the Player's configuration data (if Client has locked the Player to one ID).

For the player branding security, to restrict playable content, the player may or may not feature buttons with the capability to communicate with the system Server allowing channels to be saved to and loaded from the user's online account. For the scheduled content polling, the player will poll the system server on a regular interval for new Channel content. When configuring the Player, the Client will be given the option to select how often (in minutes) the Player should refresh the XML data from the Server.

Since resizing a compiled Flash movie can have adverse effects on the appearance of the contents, the size of the Player will be configurable by choosing one of several available Player sizes. Each size will be based on a different .swf, each compiled with the same internal Player ActionScript code, but each move will be compiled to a different target size. New sizes available on client request.

Now, the player functionality will be described in more detail. The player may play a podcast and the primary action is to stream MP3-formatted audio via HTTP request from the server specified in the XML file defining this Channel. Auto-play on startup can be a Client-configurable option. After the current stream ends, the Player auto-advances playback to the next podcast in the Channel wherein the auto-play may be configurable by the client. The playback position in each podcast should be retained for the session (only), so if the user returns to a partially heard podcast, playback will restart from the moment they stopped listening. The player may also have a play/pause button, but the podcaster/blogger optionally can choose to not allow the user to have any control over the audio playback. The player may also provide a podcast title display that is configurable. The player may also have an optional progress bar with configurable colors with elapsed time display although clicking on the progress bar will not affect audio playback. The player may also have an optional fast forward/fast reverse in podcast functionality. The player may also have an optional play next/previous button that plays the next/previous podcast in the current sequence wherein auto-advance is the player default behavior.

The player optionally may also have an up/down volume control with clickable up/down buttons to control the player's output volume. The player may also have a play list box which is a scrolling, hierarchical display of available enclosures. The play list may have a configurable background color, including none as an option, configurable text color, scrolling Playlist content that allows for arbitrarily many Channels, an optional Indicator for “new” content (arbitrary external image, loaded into the Playlist, next to the item's name), a listen to a channel button so that the user can listen to all content in the channel wherein the audio will be available as thumbnail or a full version and a listen to all channels button that plays all loaded content serially.

The player may also have user interaction buttons that are specific in-player functionality not covered by loading a pop-up window to a given URL. For example, the player may include iTunes integration that creates a pcast file with the RSS link to the podcast (or the system Channel), plus other relevant info, and transfer the pcast file to iTunes or Yahoo Music Engine by returning the pcast file to the browser. The player may also provide a button to mobilize a podcast to a client device such as a mobile phone that may not have a client application resident on the client device. The player may also include the mobilize playlist into playlists saved on system server wherein the account is automatically created for them in the system, unless one already exists (matched via e-mail address), and the selected Channel/podcast is added to their subscription list. The player may also permit the user to send a link to this Channel (by userchannel id) or Podcast (by ssid) to a friend that submits the id to the system Server (via tofriend.do process.) The player also has preferences that, if the player is unlocked, jump to the system website (arbitrary URL) to edit preferences there. The player may also have a help option that opens an arbitrary URL and play/Pause/etc, with player control hotspots will call built-in Player methods.

The player may also deliver ambient advertising to the user of the player. In particular, while a user is listening to content, Ambient Ads, with direct response opportunities can be displayed wherein the images and links are defined by XML. The player may call click-to-call (via Skype) that attempts to initiates a Skype connection to a specified telephone number (under the hood, this is really just another clickable hotspot to an arbitrary URL, but this URL is a callto: link). The player may also a click-to-transaction that is a HTTP link to perform a transaction. The player may also provide a click-to-Buy that is an HTTP link to any arbitrary Client-configured URL (probably to a commerce site), opening in new browser window. The player may also have a click for More Info that is a pop-up link to any arbitrary URL featuring more product info, as specified in the XML file defining the ad. The player may also have a scheduled Advertising Content Polling wherein the Player will poll the system server on a regular interval for new content, and new Ad content will be downloaded with the other updated enclosures.

The player may also provide player usage tracking. The usage tracking logs the listening time for every podcast the user hears and, when the Player connects to the server to check for new data, it will upload the player's usage statistics collected since the last data poll. The player will have a registration/login page built into it. The optional and mandatory registration elements will be configurable by the Client, and will be specified in the Player's defining XML. The registration box will have a configurable color scheme and a password field will be required to log in to system Servers.

Now, the player-specific XML documentation is described in more detail. The player appearance defined by the external XML may include images, hotspots, player background and ambient advertisements. The images are any number of external jpegs loaded via HTTP from Client-specified paths that may include: an image path, an alternate image (for “down” button state), an image position (x/y) coordinates, defining the image's position within the Player, an image stacking order/z-sorting—specify which images are on top, scaling that permits the client can make loaded images bigger or smaller and action that is an optional parameter specifying an ActionScript function to call (within the Player) on the on Release event for this image. The hotspots allow for user-defined clickable regions (like an image map) that may include: a target URL (or Player ActionScript function), a target_target (could be a new window, or a specific one), a hotspot position (x,y), a hotspot Size (Height and width, in px) and an optional logging parameter (e.g. “Nike_ad_{—}07_MoreInfoRequest”) that are added to the log of user activity when the user clicks the hotspot. The player background shows a solid user-defined color that is an RGB value. The ambient ad information may include a location (x,y) and a height & width that sets the size of the masked area that the ad is loaded into within the player.

The player functionality that may be defined by external XML may include server polling interval, an initial channel ID, registration data, auto-play and auto-advance. The server polling interval may be the number of seconds between polling the server and the initial Channel Id is a unique VoiceIndigo id for the first Channel to display. The registration data assumes that an email address is always present and required and additional fields can be added by the client, and can be tagged as optional or required. The auto-play and auto-advance may be true or false.

The player also has functionality that is defined by local variables wherein the data may be embedded directly into an Object tag of the webpage. The local variables may include a player ID that is a unique number that will identify the Player configuration to the server and a player size that is the path to the appropriately-sized compiled swf will be configurable by the client, so the specified movie will be loaded by whatever code (or person) embeds the Player into the webpage.

FIGS. 8A-8D illustrate an example of a branded audio content aggregation, delivery and sharing system 160 in accordance with the invention. In this example, a Nike® branded system is shown wherein the system functionality for Nike is hosted on the unit 24. The system 160 enhances the Nike brand by leveraging audio content around each of Nike's categories. The audible web is becoming more integrated with the textual web and is becoming an integral part of our daily lives. The very favorable economics of audio production and distribution using new technologies such as podcasting, RSS, and the MediaJet™ player now make it possible to get high returns on marketing spend in this rich media domain. The branded system 160 has the content unit 24 that interacts with one or more client devices 22 and further has a player 162 as described above.

In the branded system, Nike will identify podcasters around the world as contributors to the Nike Channel so that the system provides podcast aggregation as shown in FIG. 8A. In effect, the channel will be community generated, but curated by Nike. Nike will supply their podcaster community with the following (that permits Nike to deliver a compelling set of podcasts):
Guidance on recording techniques and tools.
Access to a repository of ‘pod safe’ or appropriately licensed music
A place to host their content.
Tools to create the appropriate RSS feeds.
Standard licensing terms for distribution of the content via the Nike channel.

The system permits Nike to ‘mix’ the podcasts into the Nike Soccer Channel, which can be accessed via MediaJet™ players 162 placed all over the web in blogs, portals, and Nike related websites. The Nike Channels can also be accessed via client devices 22 running the client application described above. For this branded system, the players 162 are branded and skinned exclusively for Nike, and are locked into Nike Radio channels such as Nike Soccer. In a web usage scenario, a user would run across a link to Nike Soccer Radio in a website, and open up the player.

The player 162 is written in flash so it is likely the user would not have to install any program (since flash is bundled with most browsers) in order to execute the player. If the user is new, they will be asked to register with a minimum of information (name, e-mail, mobile phone number, zip code), with extended attributes such as demographic data (such as address, occupation, age, etc.) being optional. Each user would then have the option of listening to Nike Radio podcasts either by streaming or pre-downloading the content. If they choose download, then they have the option of placing the files into a folder of their choice, and adding them directly to their iTunes library. An account is automatically created for them in the data storage unit 60 of the system 160, unless one already exists (matched via e-mail address), and the Nike Radio is added to their list of Channels. The player automatically downloads content for users every 24 hours, or as specified by the end user.

The user can listen to content on the desktop via the MediaJet player whether it is downloaded or streamed. The player 162 tracks who is listening to what and feeds this information back to Nike. While a user is listening to content, Ambient Ads, with direct response opportunities can be displayed. Capabilities include ‘Click-to-Request’, ‘Click-to-Call’ (via skype), ‘Click-to-Buy’ via a link directly to a Nike commerce enabled website.

The system 160 provides Nike with the player 162 that is branded (skinable and lockable for one or more channels), provides unlimited distribution since it is easy to place flash object, provides downloads with automatic retrievals and streams content. The player also integrates with client devices including portable MP3 devices, cellphones, and other devices that may include iTunes and VoiceIndigo Mobile. The player provide ambient advertising as set forth above and tracks detailed statistics including usage, demographics and advertising vitals.

FIG. 8B illustrates the player 162 that provides the ambient advertising on the player while FIG. 8C illustrate the ambient advertising on a client device 22. In FIG. 8C, a first user interface displays a Nike specific advertisement with the podcast content wherein the user is also provides a Call button that permits the user to call Nike and order the shoes as shown in a user interface 166.

In the branded system shown in FIG. 8A, the consumer does not interact directly with the MediaHub 24, but only does so through the MediaJet player 162 branded for Nike. The MediaHub 24 provides the following functions for Nike:
Skin Control
Channel Definition
MediaJet™ Player Preference Control
   Locking of Channels
Management of Multiple Locked Players
Advertising Control
   Creative Upload
   Ambient Advertising Control Panel
   Reporting of Advertising Vitals
General Reporting
   Member Community
   Demographic
   Usage

FIG. 8D illustrates a Nike digital administrator page 168 that is served by the web server 32 of the unit 24. The web page permits Nike to manage its channel in the content system, such as defined one or more channels unique to Nike (Nike Basketball, Nike Tennis, Nike Soccer, etc. as shown in FIG. 8D), one or more skins for the Nike player, advertising for the Nike channels, reports from the content system and preferences for the Nike branded system. Now, examples of the user interface for the web pages generated by the unit 24 for a non-client device browser as well as the user interface for a client device will be described.

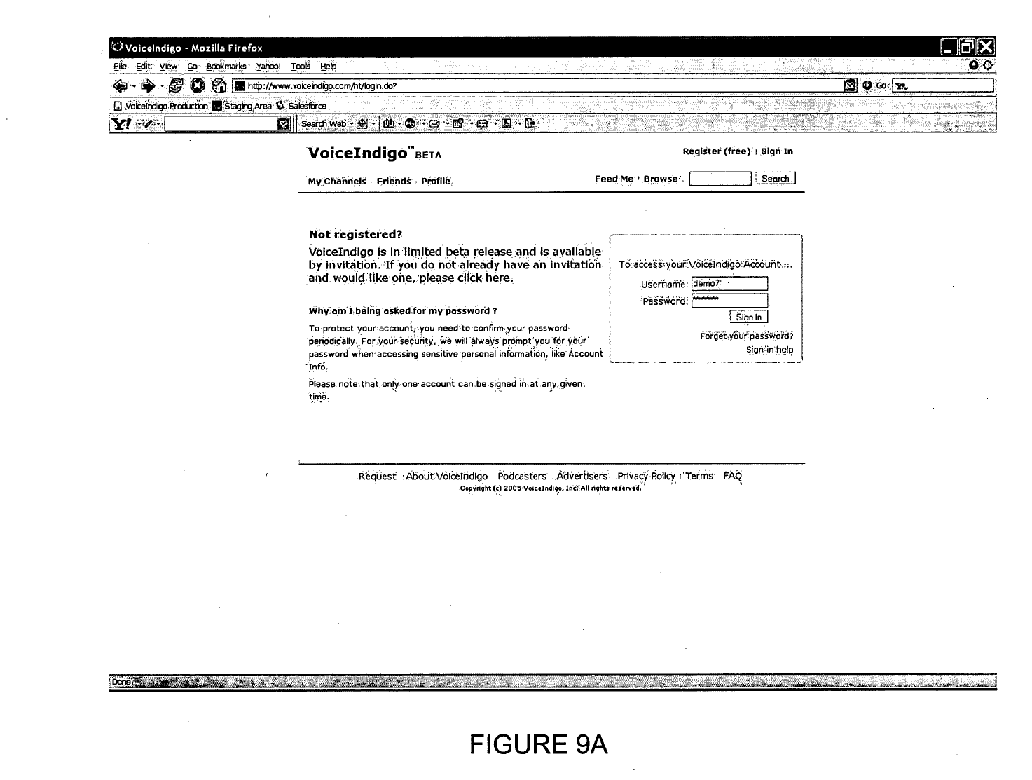

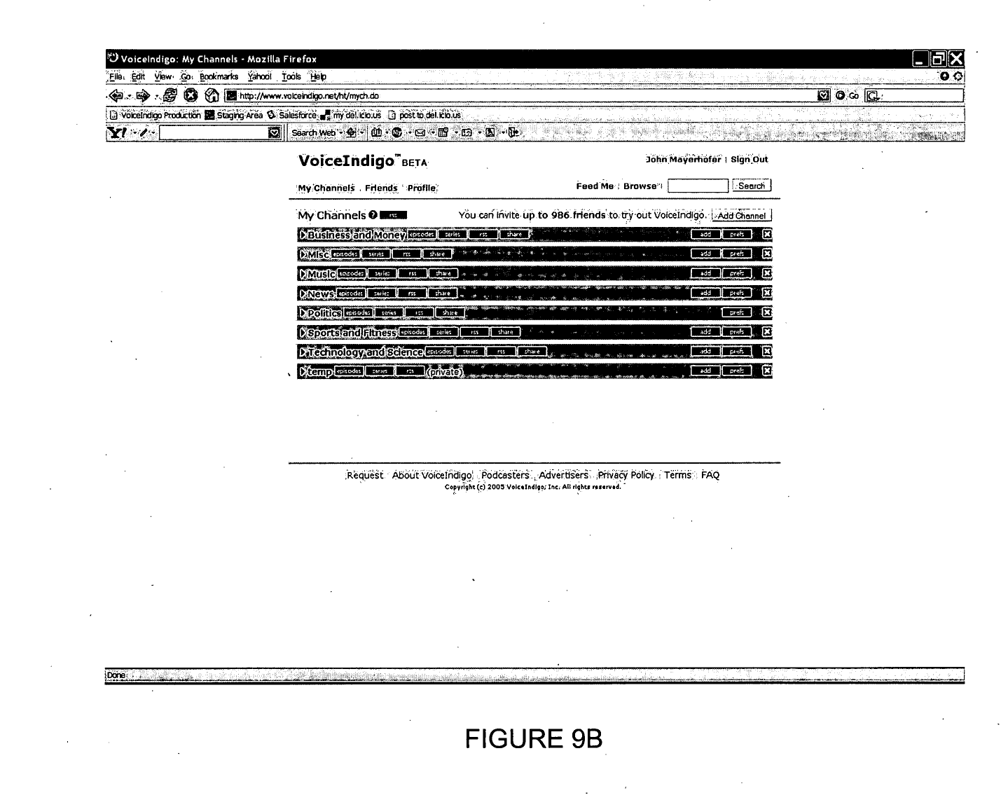

FIG. 9A is an example of a user interface for logging into the system. The service functions of the system 20 may be accessed through a variety of mechanisms including an HTML browser, XML Web Services, WAP, or the client application on the client device. A website that is generated by the system 20 (an example of an implementation of this website can be viewed at www.VoiceIndigo.com) provides a portal (HTML interface) for users to find, organize, listen, and share content. The website may also include self-service areas for Podcasters, Advertisers, and general corporate information. In order to access the main functions of the consumer portal (or the Podcaster or Advertiser areas), the user must login using a username and password as shown in FIG. 9A.

FIG. 9B is an example of a user interface that lists podcasting channels once the user logs into the system. In the exemplary implementation, this user interface may be known as a personalized MyChannels page. The user interface displays a list of the channels selected by the user with options for viewing them by series, episode, viewing an RSS feed for the whole channel (or even all the channels), sharing a channel, adding new programs, editing preferences, or deleting a channel. The channels are collections of podcasts similar to a playlist. The channels permit the user to set preferences for each channel (such as ‘synch with my cellphone’, ‘only download content that is less than 10 minutes in length’, etc.) A user can also share channels. For example, a user can select various podcasts such as ITConversations, PodTech, and Inside Digital Media for the technology channel and choose to synchronize this channel with my Nokia 6630 and subscribe to a news channel configured by another user. In addition to setting preferences, channels can also be shared with other users by clicking on the share link wherein the sharing is implemented either via e-mail or SMS. Users can also invite other users and choose to share their channels via e-mail or SMS.

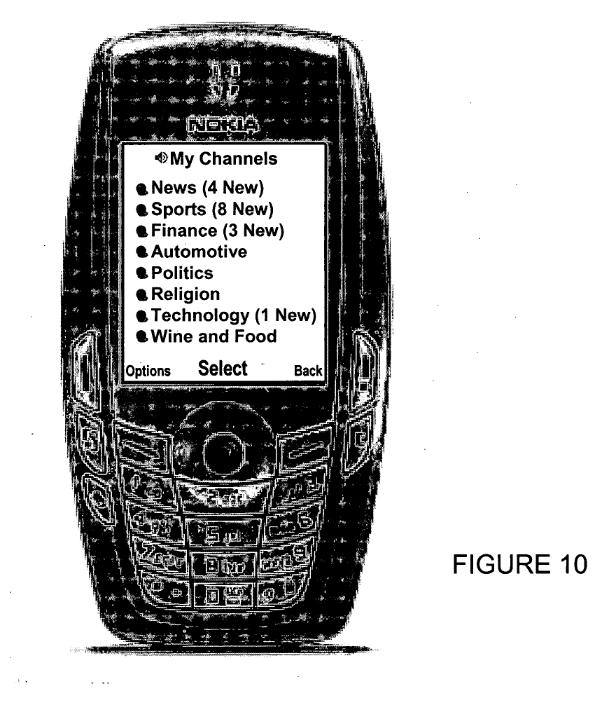

FIG. 10 is an example of a client device user interface for the postcasting channels. As shown in FIG. 10, the same collection of channels shown on MyChannels page in FIG. 9B has been synchronized with the client device. Each of the channels can be accessed from this first screen of the client application running on this client device, which is a Symbian phone in these examples. In accordance with the invention, the content has been automatically downloaded according to preferences.

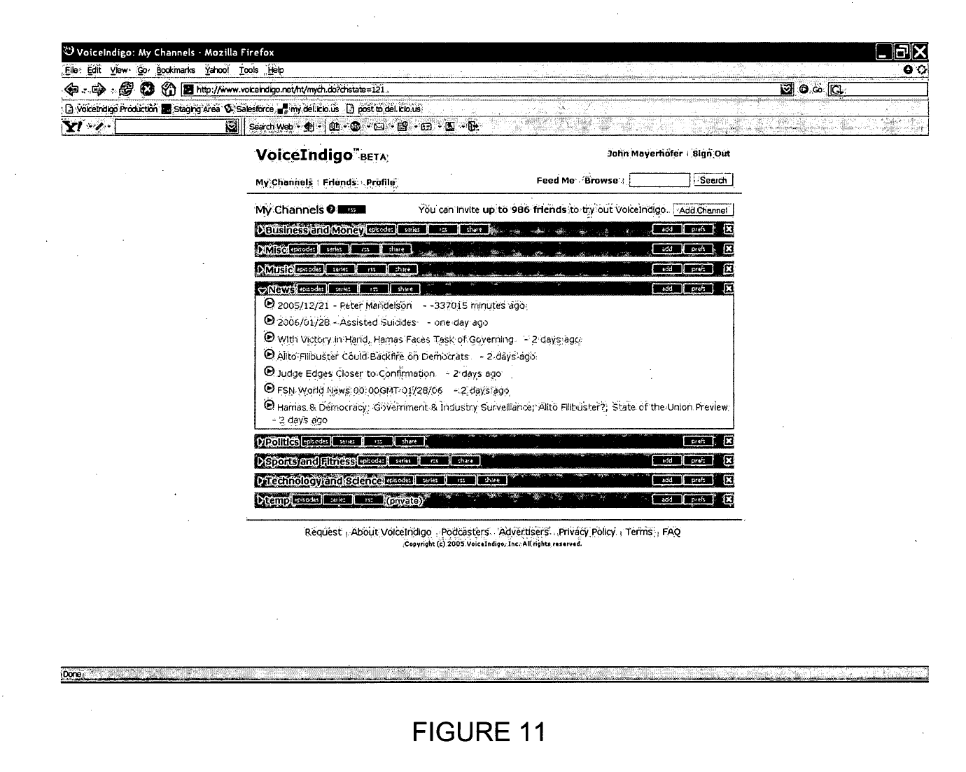

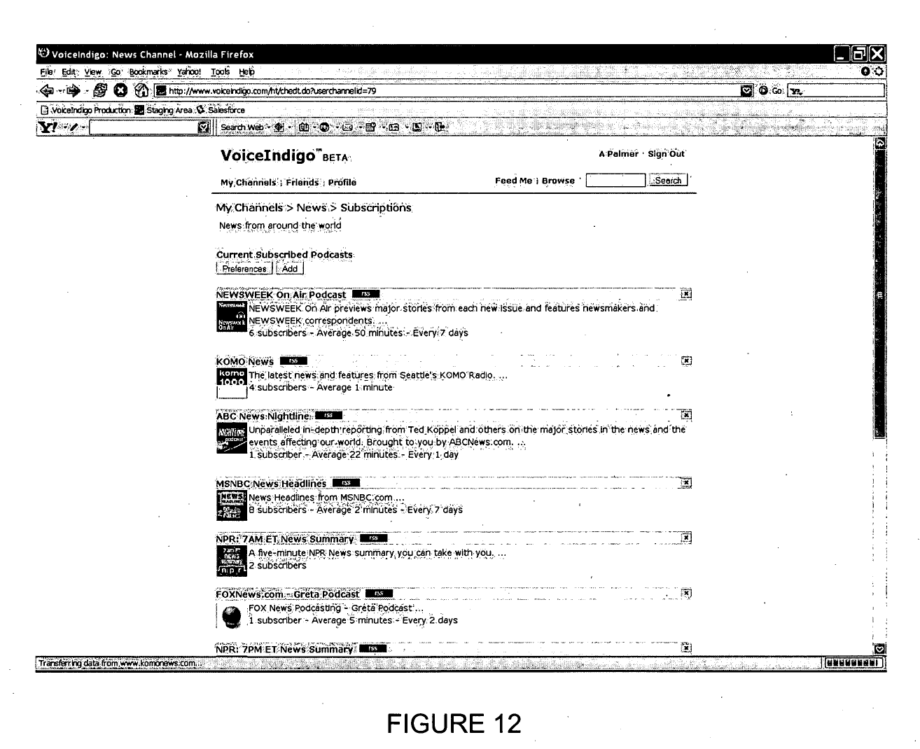

FIG. 11 is an example of a user interface with an expanded channel with episodes. In particular, this view shows one of the channels expanded and showing the particular episodes belonging to podcast series to which you have subscribed, that have recently been retrieved by the system. FIG. 12 is an example of a user interface with podcast series list wherein the particular podcast series belong to a channel created by the user.

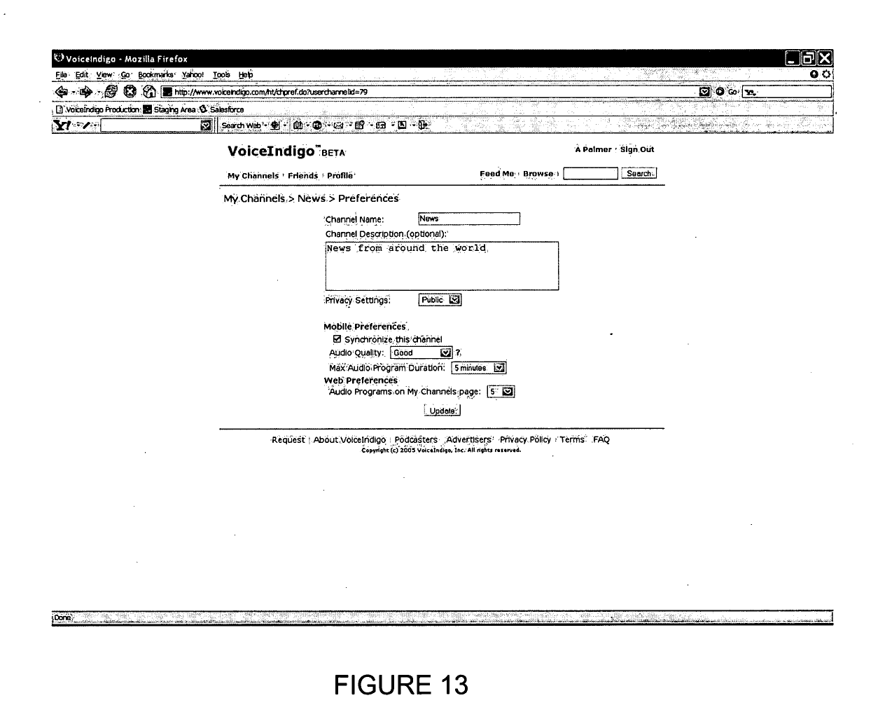

FIG. 13 is an example of a user interface with channel preferences. As shown, channels can be made public, private, or even be made available only to certain groups (defined in the system's Friends module). The user can also specify whether a channel is to be synchronized with the client device of the user either directly through the application client for that client device or through the ‘mobilize’ method described above. The user may also choose various levels of audio quality to match the type of content to which you are listening and optimize the download speed. The user may also choose to filter content with a duration longer than what you set, or just synchronize the first X minutes of the content with your client device.

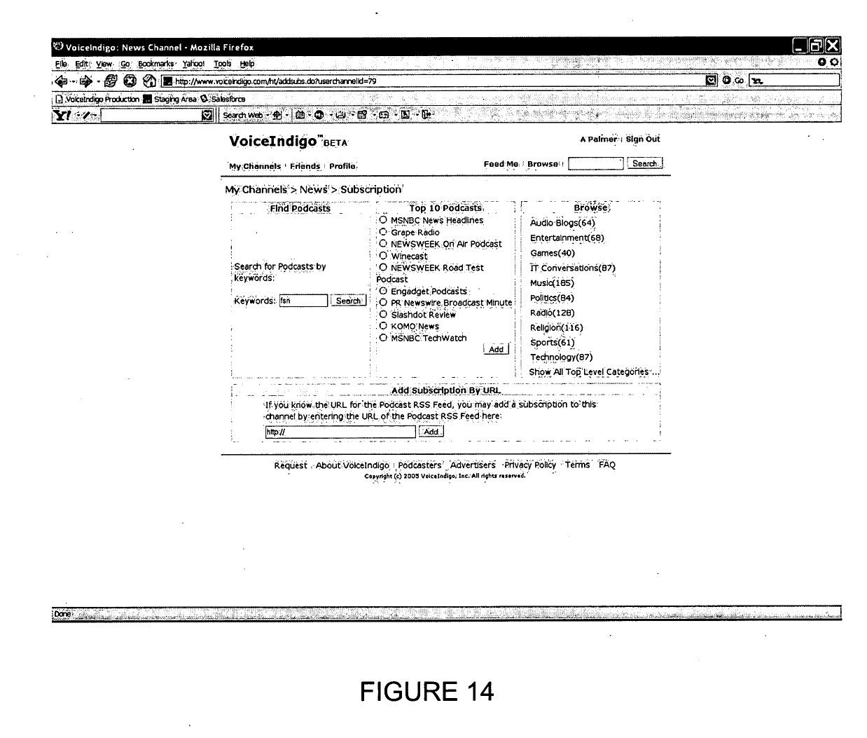

FIG. 14 is an example of a user interface for adding a podcast series to a channel. The user can add a podcast series to a channel in a number of ways including searching for it using one or more keywords, choosing a podcast series from a list of popular podcasts, browsing a directory or adding an RSS feed by entering the appropriate URL.

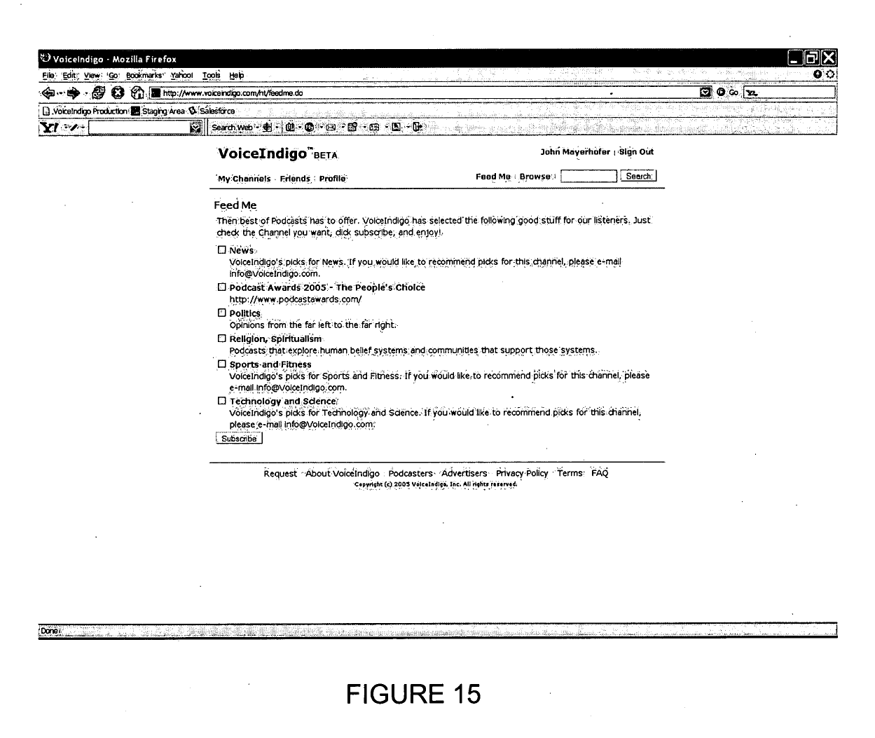

FIG. 15 is an example of a user interface for subscribing to a channel. The user interface permits a user to use pre-defined channels from the system 20.

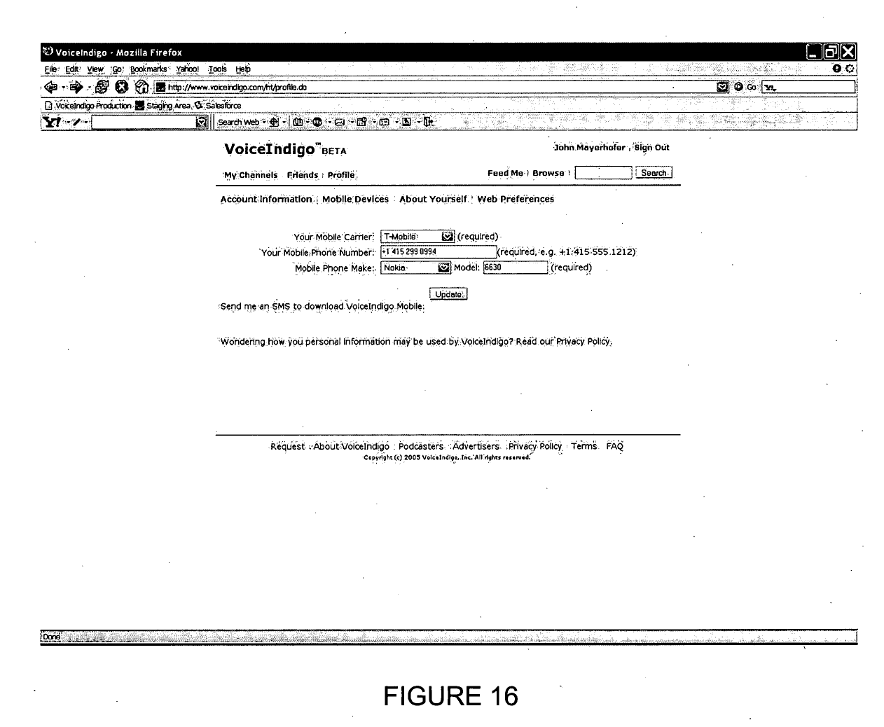

FIG. 16 is an example of a user interface for user preferences. The system tracks a number of preferences ranging from basic account information to information about the client device of the user, to personal demographics, and preferences for display of information in the system on the web. A listener may update these, and much of this information is voluntary. Under mobile preferences, the system makes it very easy for the user to get the application via SMS and tracks which carrier is used by the user and the model of the client device of the user. The preference information that is tracked makes it easier to service the constituents, whether it be the consumer, and OEM, an MSO, a content provider, or an advertiser.

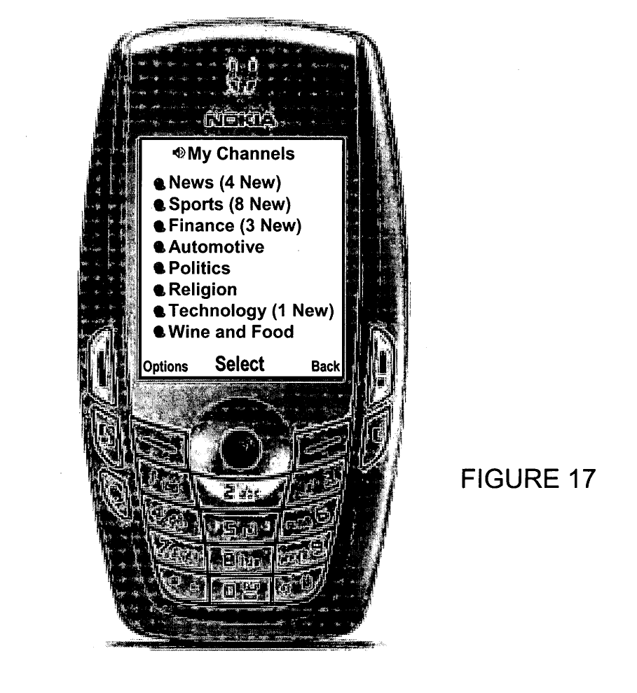

FIG. 17 is an example of a user interface for a client device when a user first starts the client application on the client device. This screen shows all of the personalized channels, and provides the user with an indication of new content. For example, under news, FIG. 17 shows that the user is informed that there are 4 new episodes.

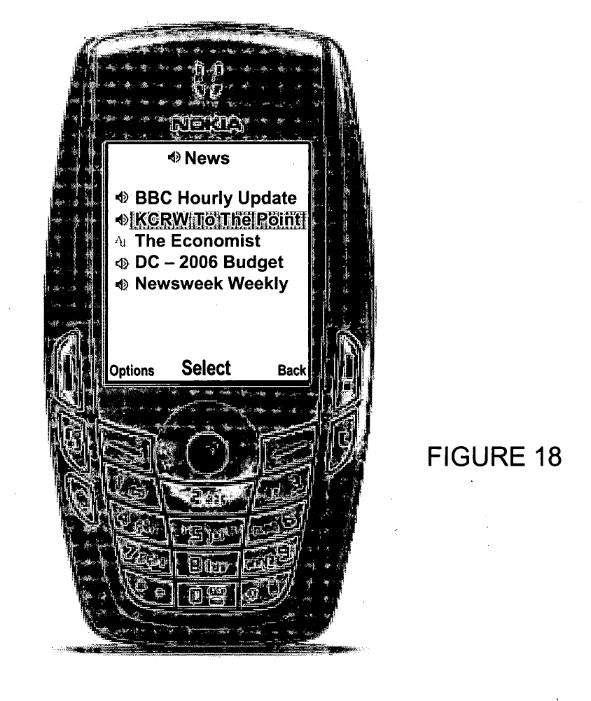

FIG. 18 is an example of a user interface for a client device when the user selects a channel from the user interface in FIG. 17. By clicking on news, the user sees the episodes of the podcast series that exist in the News channel as shown in FIG. 18. The user interface also contains an Interstitial ad placed in the channel (“The Economist”) wherein the channel interstitials are Ambient Ads with Audio directly related to the ad.

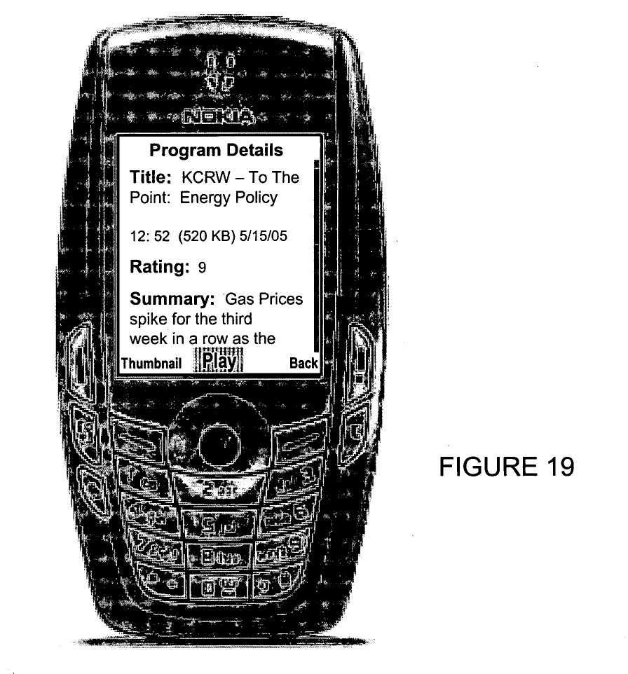

FIG. 19 is an example of a user interface for a client device when the user selects a particular episode shown in FIG. 18. In particular, the user selects the KCRW program, the user can view the metadata for that episode as shown in FIG. 19. In this example, the user can see the title, the duration, the size, the publication date, a summary, community or Smart Ratings. The user can also choose to listen to an audio thumbnail of that episode.

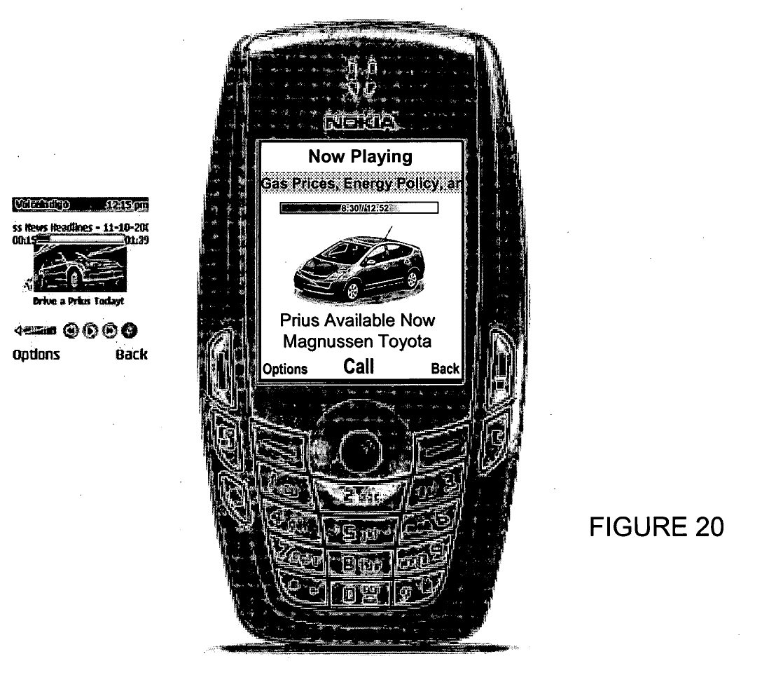

FIG. 20 is an example of a user interface for a client device when the client device plays a piece of digital audio content so that once the user decides to play the episode, the player screen shown in FIG. 20 is presented to the user where one or more Ambient Ads appear throughout the time period when the program plays. Two examples of the advertisements are shown. The ambient ads have a visual component, a text component, and one or more specified direct response paths back to the advertiser (in this example, the direct response paths include a option to call the advertiser directly using the “Call” button. These standard elements make a self-service ad buy very easy. The advertisements appear on the player screen with the text below it and the direct response paths are accessed through buttons or menus. The direct response paths may include click-to-call (shown in FIG. 20), click-to-request, click-to-buy, or other. The ambient ads can be matched based on the context of the channel, series, episode, and/or individual listener.

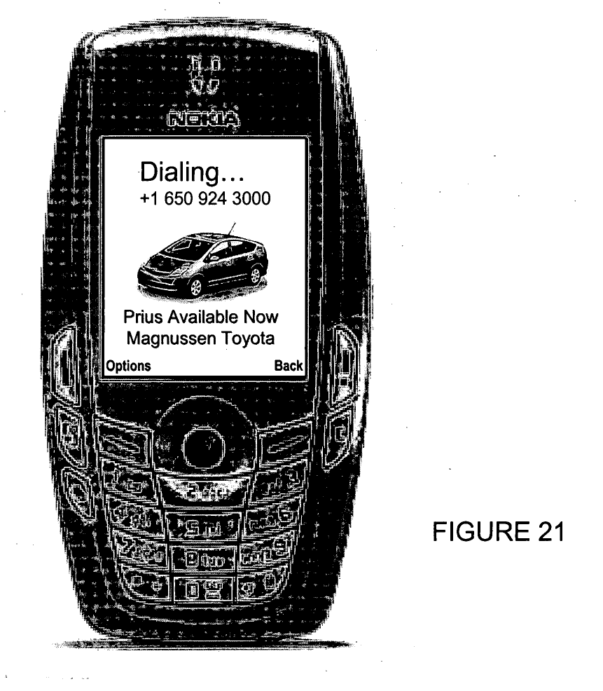

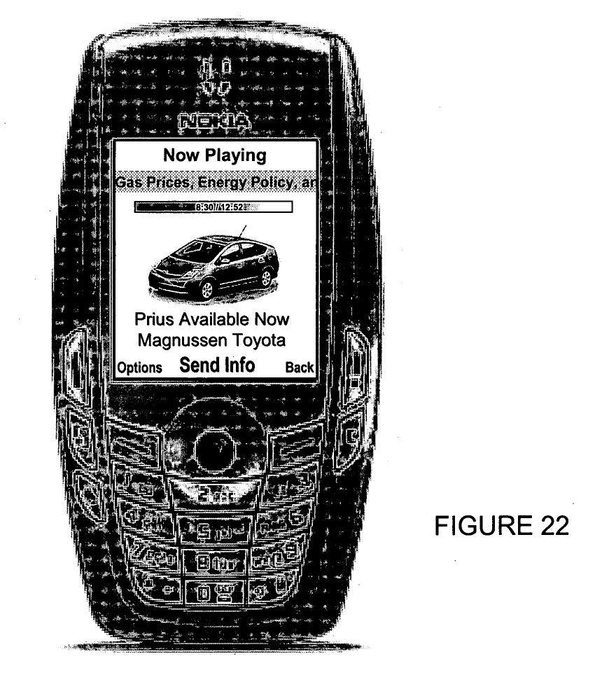

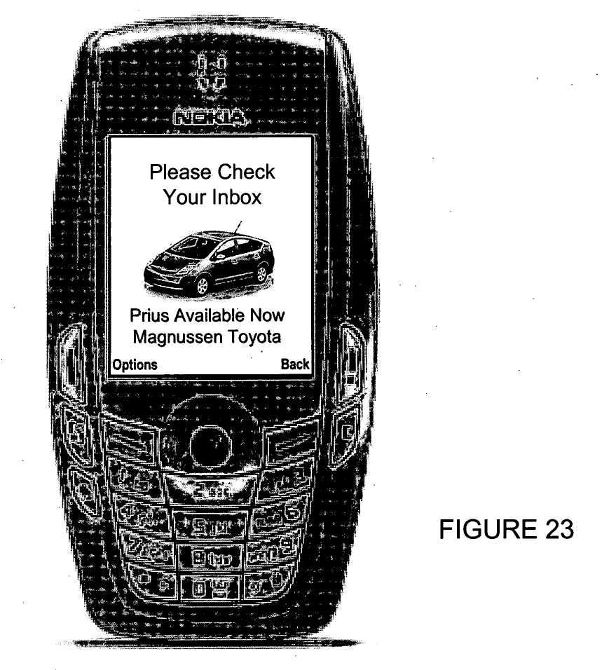

FIG. 21 is an example of a user interface for a client device when the user selects call from the user interface shown in FIG. 20. When the user selects the call function, the phone dials the number provided by the advertiser. FIG. 22 is an example of a user interface for a client device when the user selects “Send Info” or “Request” from the user interface. If the user selects the ‘Send Info’ or ‘Request’ information from the advertiser is sent via e-mail, SMS, call-back, and/or standard mail, depending on the options chosen by the advertiser. FIG. 23 is an example of a user interface for a client device when the user receives a confirmation message for the “Send Info” command.

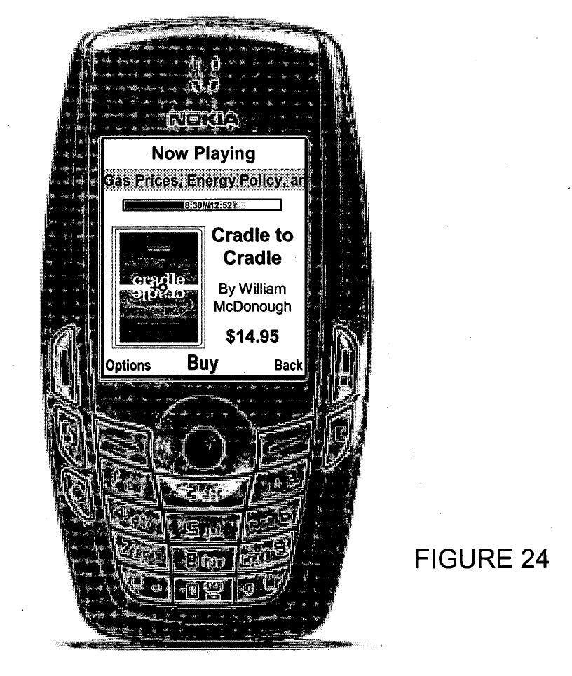

FIG. 24 is an example of a user interface for a client device when the user is presented with a “click-to-buy” option. In this case, the listener sees a picture of the item for sale, some associated text, and has an option to buy using the “Buy” button. Depending on the specific distribution partner through which we acquired the consumer, paths to enabling this include use of the carriers billing on behalf of others (BOBO), Premium SMS, commerce functionality from aggregators (e.g., Cellmania), various PayPal offerings (such as micropayments, pre-approved buyers, and masspay), and our own merchant capabilities. Note that these same payment infrastructure alternatives are also used for purchase of content itself in some cases, or for listeners in a community to donate to a specific content provider.

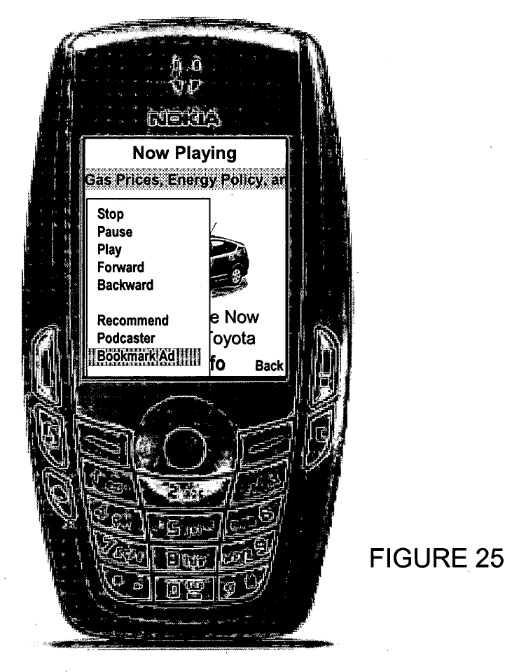

FIG. 25 is an example of a user interface for a client device when the user bookmarks an advertisement. In particular, if a consumer does not want to respond to an ad in any way at that time, they can choose a menu option to bookmark the ad for later use.

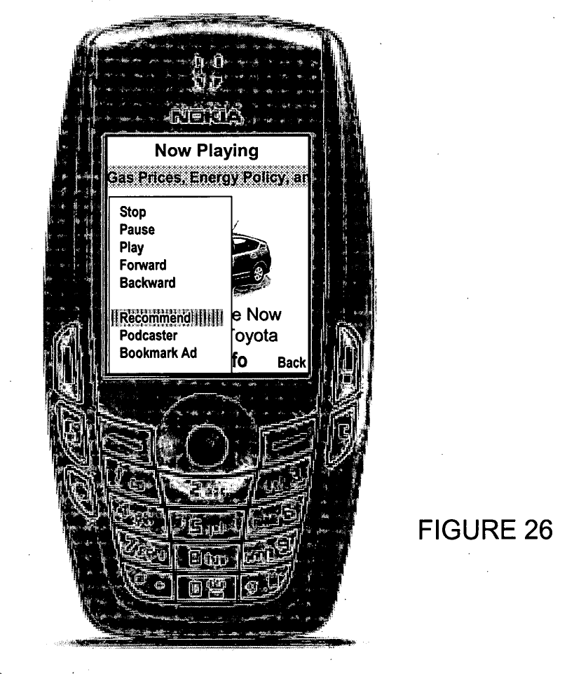

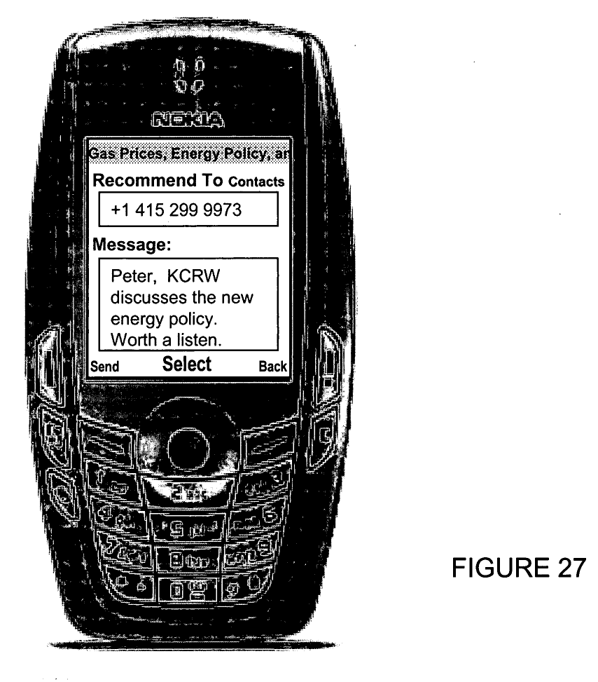

FIG. 26 is an example of a user interface for a client device when the user recommends programs to other users. The user recommends the programs by choosing recommend from the Options menu. The recommend works via SMS or E-Mail and we integrate with the users local address book. FIG. 27 is an example of a recommend user interface for a client device wherein users can recommend programs to others by choosing recommend from the Options menu.

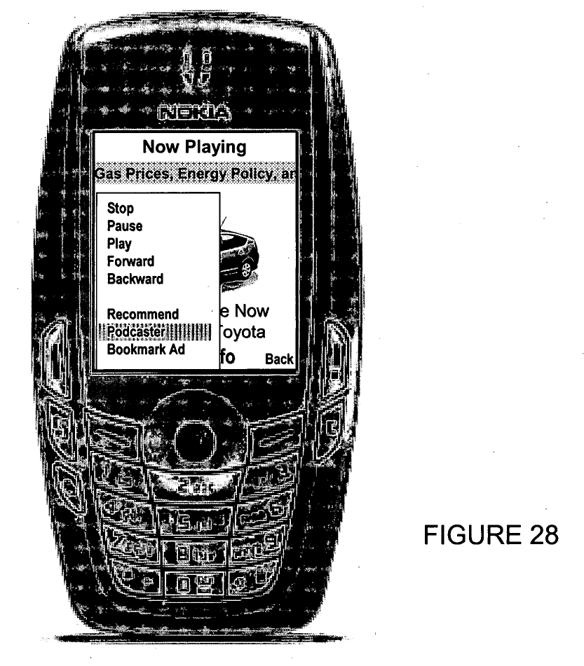

FIG. 28 is an example of a user interface for a client device so that content providers connect with the user, In particular, besides providing a direct response path to the advertiser, the system also enables content providers to connect directly with their audience in a number of compelling ways such as by contacting the podcaster.

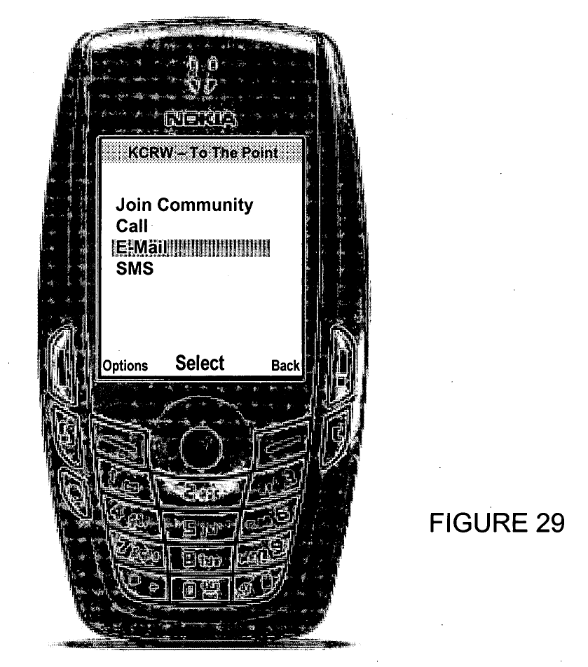

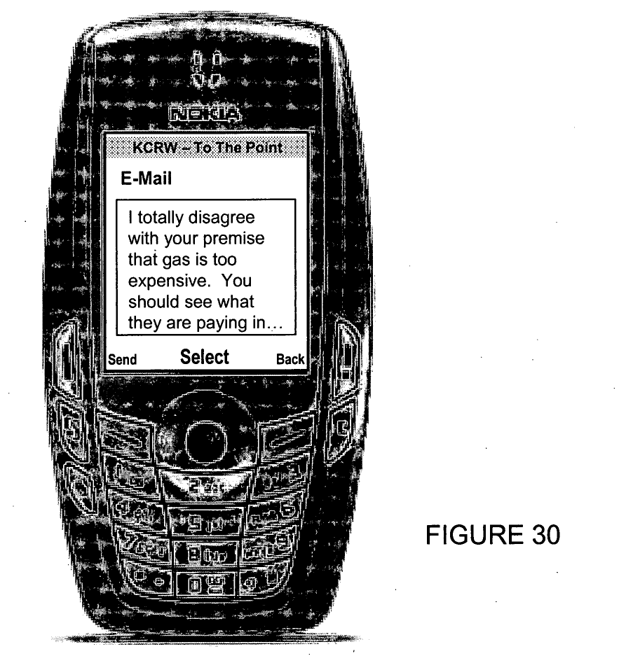

FIG. 29 is an example of a user interface for a client device when the user is listening to a piece of digital audio content. The user can choose to: Join Community—Submit basic contact details to the content provider (which is accessed through a content provider dashboard); Call—Call to a phone number that the content provider provides; E-Mail—E-mail the content provider; or SMS—SMS to a mobile phone number that the content provider provides to the user. FIG. 30 is an example of a user interface for a client device when the user selects to send an email message to the content provider and is presented with a text box in which to enter their message.

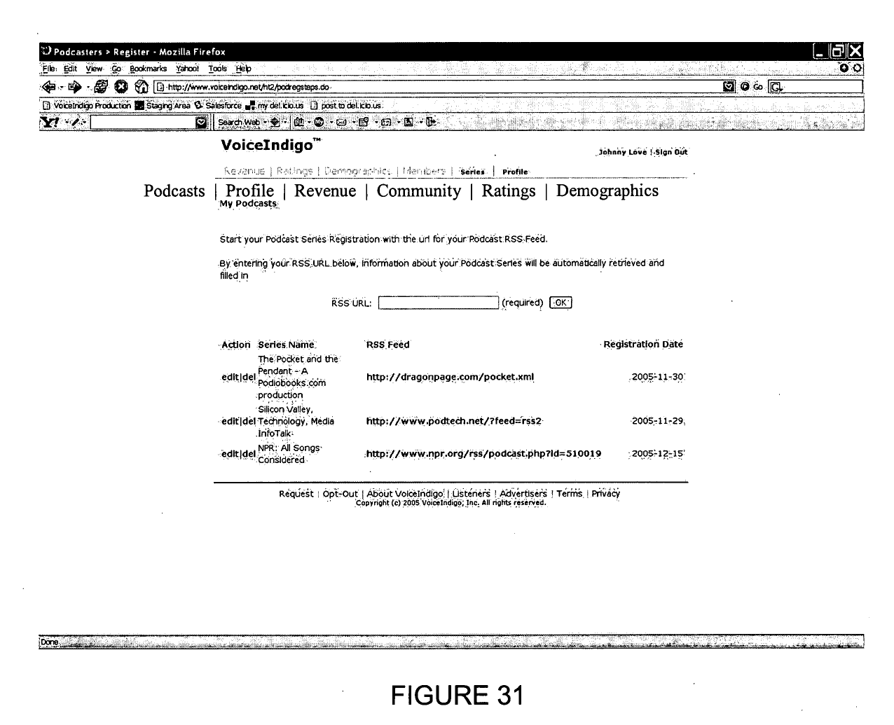

FIG. 31 is an example of a user interface for a podcaster section of the system. The Podcasters log into their account at the podcaster portal with a username and password. Once a podcaster logs into the Podcaster portal, they are brought to a screen that shows a list of their registered podcast feeds. These feeds are subject to the click-through content license agreement that you completed during the registration process. The podcaster may add more feeds or delete feeds via this screen.

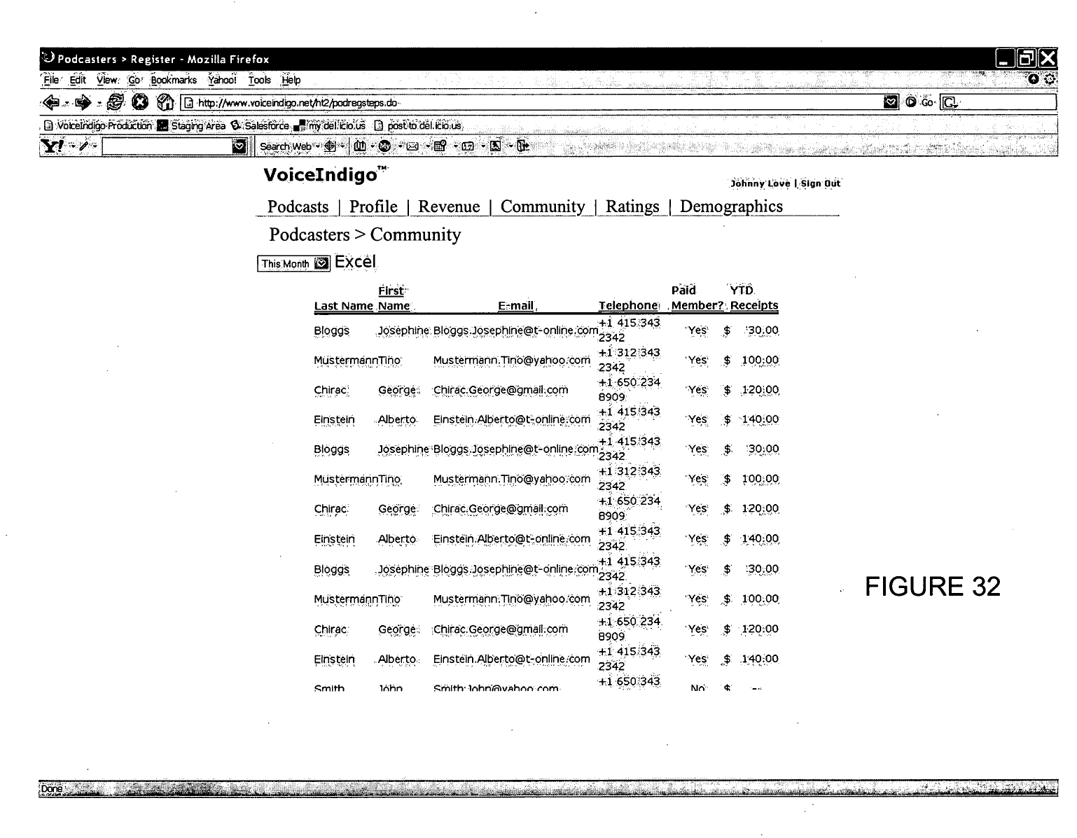

FIG. 32 is an example of a user interface for a podcaster showing the details of each user that listens to the particular podcaster. If listeners opt-in to the podcaster's community, the podcaster will have access to their contact details on this podcaster dashboard. The podcaster may choose to export them into Excel as well. In addition, if listeners choose to donate money to the podcaster via our ‘mobile tip jar’, the total donations by listeners for the displayed period show here.

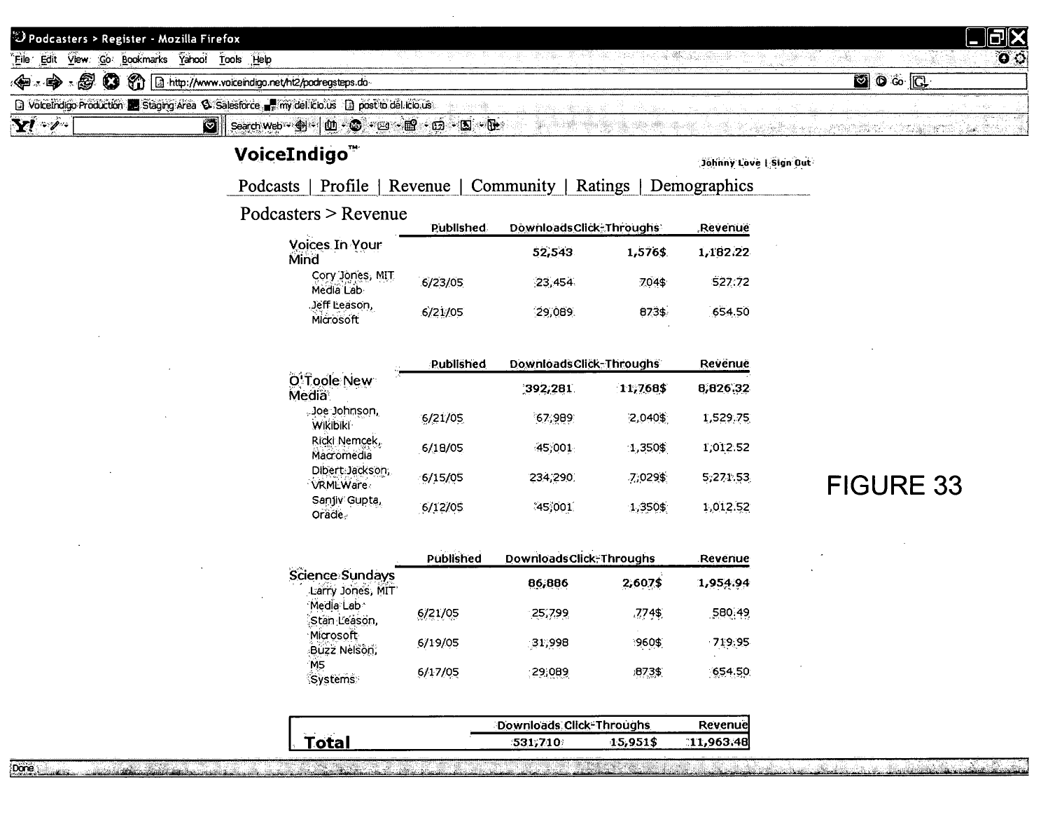

FIG. 33 is an example of a user interface for a revenue dashboard for a podcaster. In particular, this podcaster dashboard shows the podcaster by Series and Episode how many downloads and clickthroughs they had for each episode, and the total amount of revenue associated with each of them.

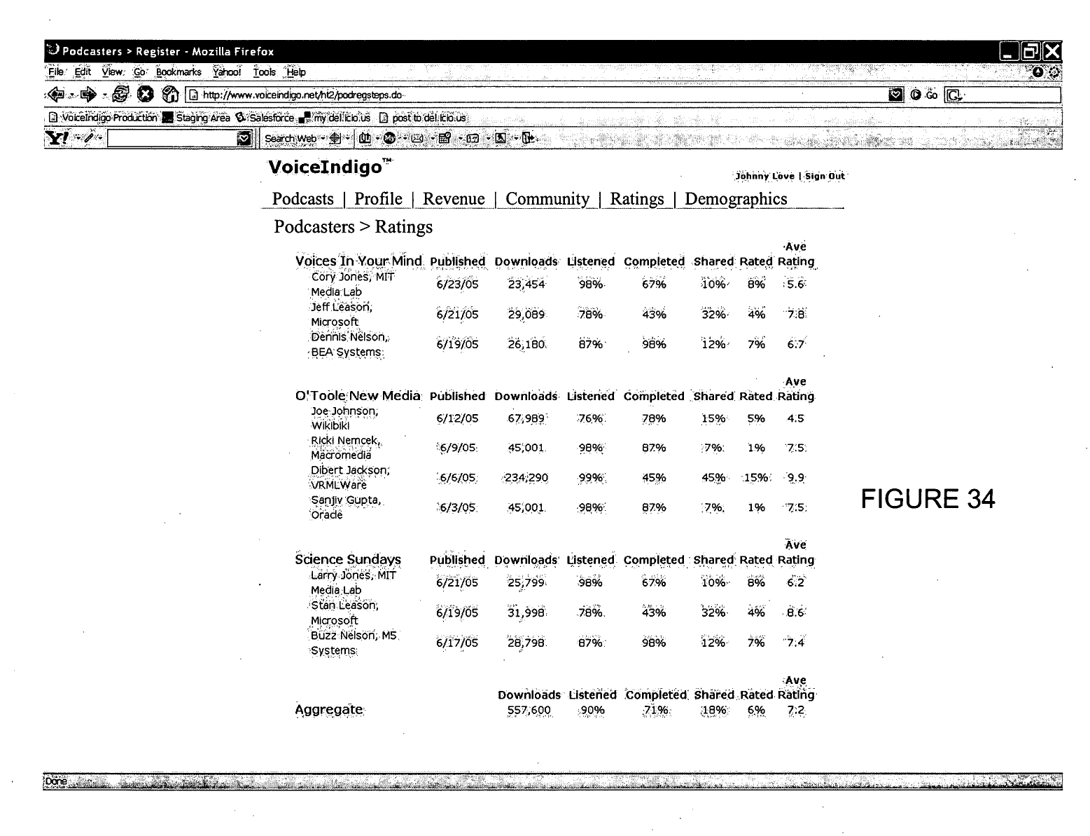

FIG. 34 is an example of a user interface for a ratings dashboard for a podcaster. This podcaster dashboard shows the podcaster by series and episode how many downloads they had, how many shows were listened to, how many completed, how many shared, how many were rated by listeners, and the average rating they received.

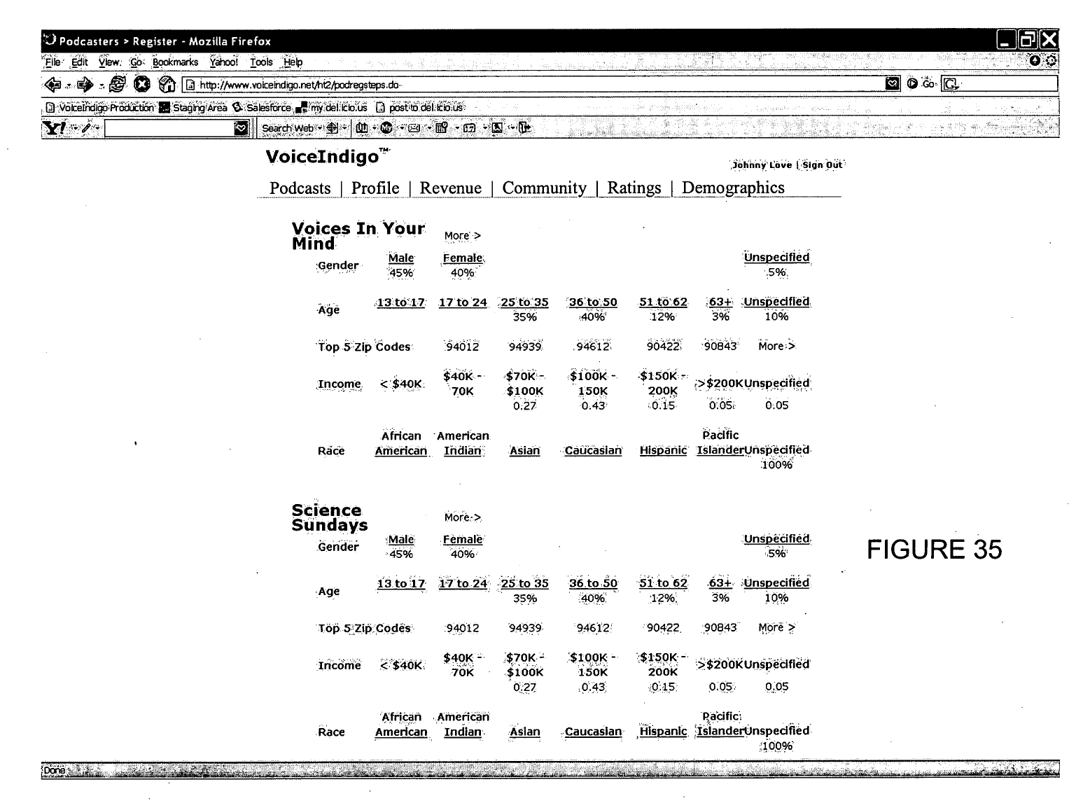

FIG. 35 is an example of a user interface for a demographics dashboard for a podcaster. This podcaster dashboard shows the podcaster typical demographics such as age, geography, income, race for each of their podcast series.

While the foregoing has been with reference to a particular embodiment of the invention, it will be appreciated by those skilled in the art that changes in this embodiment may be made without departing from the principles and spirit of the invention, the scope of which is defined by the appended claims.

1. A podcast content aggregation, delivery and sharing system, comprising:
one or more client devices;
a podcast unit periodically coupled to the client devices over a communications path wherein the podcast unit further comprises a storage unit containing a plurality of podcasts, an aggregating unit that gathers a podcast episode and stores it in the storage unit, a podcast management unit that manages the podcasts for users of the client devices based on a set of podcast preferences of each user, an advertisement unit that determines whether to place accompany the podcast with an advertisement for a podcast destined for a particular client device based on a set of statistics associated with the client device; a podcast delivery unit that is capable of delivering the podcasts contained in the storage unit and the advertisements accompanying the podcast for the particular client device to the particular client device based on the set of podcast preferences of the particular user of the client device using the communications path; and
wherein each client device is able to play the podcasts downloaded from the podcast unit.

2. The system of claim 1, wherein each client device further comprising a media player executed by a processor of the client device wherein the media player plays the podcasts downloaded from the podcast unit.

3. The system of claim 2, wherein the media player is branded.

4. The system of claim 2, wherein each client device further comprises a client application executed to a processor of the client device wherein the client application gathers podcast usage statistics for the client device.

5. The system of claim 4, wherein the client application further comprises means for periodically communicating the podcast usage statistics to the podcast unit.

6. The system of claim 5, wherein the podcast unit further comprises means for rating a podcast based on the received podcast usage statistics.

7. The system of claim 1, wherein the advertisement unit further comprises means for matching a personalized advertisement to a podcast based on a set of user advertisement preferences.

8. The system of claim 1 further comprising an affiliate site having a podcast therein wherein the affiliate site further comprises a mobilize button that permits the podcast on the affiliate site to be delivered to the client device of a user when the user engages the mobilize button on the affiliate site.

9. The system of claim 7, wherein the advertisement unit further comprises an advertisement storage unit having a plurality of advertisements, the plurality of advertisements including a visual overlay advertisement, an optional audio segment and a direct response overlay advertisement.

10. The system of claim 9, wherein the direct response overlay advertisement further comprises a click to transaction advertisement, a click to call advertisement, a click to buy advertisement and a click for more information advertisement.

11. The system of claim 1, wherein the podcast management unit further comprises means for organizing the podcasts into one or more channels and wherein a podcast is organized into the one or more channels.

12. The system of claim 2, wherein the client device further comprises means for bookmarking an advertisement contained in a podcast wherein the user can later view the bookmarked advertisement.

13. The system of claim 1, wherein the podcast unit further comprises a mobile tip jar wherein a user of a client device can provide a monetary unit to a particular podcaster.

14. The system of claim 1 further comprising one or more sites coupled to the podcast unit using an application service provider model.

15. The system of claim 1, wherein the communications path further comprises one of a wireless network, a cellular network, a computer network and a wired connection between the client device and another client device that has access to the communications path.

16. The system of claim 15, wherein each client device further comprises one of a mobile phone, a PDA device, a wireless email device, a laptop computer, a personal computer, a tablet computer, a set-top box and a computer-based device.

17. The system of claim 1, wherein each client device further comprises a client application executed to a processor of the client device wherein the client application further comprises means for generating an notification message using an SMS communication path to the podcast unit, means for selecting the content on the podcast unit using a WAP browser on the client device and means for downloading the selected content from the podcast unit over a WAP communication path.

18. The system of claim 1, wherein the podcast unit further comprises a publisher unit that further comprises means for determining ratings of a particular podcast and means for providing feedback to a publisher of the particular podcast.

19. The system of claim 18, wherein the means for determining ratings further comprises means for generating an implicit rating for the particular podcast based on a listening pattern of a user to the particular podcast.

20. The system of claim 1, wherein each client device further comprises means for exchanging a token with the podcast unit to configure the client device.

21. The system of claim 1, wherein the podcast unit further comprises a validation unit that communicates a token to each podcast publisher in order to validate the podcast.

22. The system of claim 1, wherein the storage unit further comprises one or more content clippings that can be downloaded to a client device.

23. The system of claim 1, wherein the podcast unit further comprises a transcoding unit that converts incoming content into one or more formats for delivery to the client devices.

24. The system of claim 23, wherein the transcoding unit further comprises means for generating a plurality of podcast previews that can be downloaded to a client device.

25. The system of claim 1, wherein the podcast delivery unit further comprises means for publishing the podcasts to a website on a periodic basis.

26. The system of claim 1, wherein each client device further comprises a client application executed to a processor of the client device wherein the client application further comprises means for managing the storage space of the content on the client device.

27. The system of claim 1, wherein each client device further comprises a client application executed to a processor of the client device wherein the client application further comprises means for providing direct feedback to a publisher.

28. The system of claim 11, wherein the podcast unit further comprises means for establishing a friends list having a group of users wherein a channel is shared between users in the friends list.

29. The system of claim 1, wherein the podcast management unit further comprises means for automatically downloading podcasts to a particular client device based on a set of content preferences of the user of the particular client device.

30. The system of claim 28, wherein the podcast management unit further comprises a user inbox wherein a user on the friends list places a podcast into the user inbox to share the podcast with the user.

31. The system of claim 1, wherein the aggregating unit further comprises means for receiving a piece of content wherein the piece of content has a disassembly instruction embedded in the piece of content and means for reorganizing the content based on the disassembly instruction.

32. A podcast unit periodically coupled to the client devices over a communications path for content aggregation, delivery and sharing, the podcast unit comprising:
a storage unit containing a plurality of podcasts;
an aggregating unit that gathers a podcast episode and stores it in the storage unit;
a podcast management unit that manages the podcasts for users of the client devices based on a set of podcast preferences of each user;
an advertisement unit that determines whether to place accompany the podcast with an advertisement for a podcast destined for a particular client device based on a set of statistics associated with the client device; and
a podcast delivery unit that is capable of delivering the podcasts contained in the storage unit and the advertisements accompanying the podcast for the particular client device to the particular client device based on the set of podcast preferences of the particular user of the client device using the communications path.

33. The podcast unit of claim 32 further comprising means for rating a podcast based on the received podcast usage statistics.

34. The podcast unit of claim 32, wherein the advertisement unit further comprises means for matching a personalized advertisement to a podcast based on a set of user advertisement preferences.

35. The podcast unit of claim 32 further comprising an affiliate site having a podcast therein wherein the affiliate site further comprises a mobilize button that permits the podcast on the affiliate site to be delivered to the client device of a user when the user engages the mobilize button on the affiliate site.

36. The podcast unit of claim 34, wherein the advertisement unit further comprises an advertisement storage unit having a plurality of advertisements, the plurality of advertisements including a visual overlay advertisement, an optional audio segment and a direct response overlay advertisement.

37. The podcast unit of claim 36, wherein the direct response overlay advertisement further comprises a click to call advertisement, a click to buy advertisement and a click for more information advertisement.

38. The podcast unit of claim 32, wherein the podcast management unit further comprises means for organizing the podcasts into one or more channels and wherein a podcast is organized into one or more channels.

39. The podcast unit of claim 32, wherein the podcast unit further comprises a mobile tip jar wherein a user of a client device can provide a monetary unit to a particular podcaster.

40. The podcast unit of claim 32 further comprising one or more affiliate sites coupled to the podcast unit using an application service provider model.

41. The podcast unit of claim 32, wherein the communications path further comprises one of a wireless network, a cellular network, a computer network and a wired connection between the client device and another client device that has access to the communications path.

42. The podcast unit of claim 32 further comprising a publisher unit that further comprises means for determining ratings of a particular podcast and means for providing feedback to a publisher of the particular podcast.

43. The podcast unit of claim 42, wherein the means for determining ratings further comprises means for generating an implicit rating for the particular podcast based on a listening pattern of a user to the particular podcast.

44. The podcast unit of claim 32 further comprising a validation unit that communicates a token to each podcast publisher in order to validate the podcast.

45. The podcast unit of claim 32, wherein the storage unit further comprises one or more content clippings that can be downloaded to a client device.

46. The podcast unit of claim 32 further comprising a transcoding unit that converts incoming content into one or more formats for delivery to the client devices.

47. The podcast unit of claim 46, wherein the transcoding unit further comprises means for generating a plurality of podcast previews that can be downloaded to a client device.

48. The podcast unit of claim 32, wherein the podcast delivery unit further comprises means for publishing the podcasts to a website on a periodic basis.

49. The podcast unit of claim 38, wherein the podcast unit further comprises means for establishing a friends list having a group of users wherein a channel is shared between users in the friends list.

50. The podcast unit of claim 32, wherein the podcast management unit further comprises means for automatically downloading podcasts to a particular client device based on a set of content preferences of the user of the particular client device.

51. The podcast unit of claim 49, wherein the podcast management unit further comprises a user inbox wherein a user on the friends list places a podcast into the user inbox to share the podcast with the user.

52. The podcast unit of claim 32, wherein the aggregating unit further comprises means for receiving a piece of content wherein the piece of content has a disassembly instruction embedded in the piece of content and means for reorganizing the content based on the disassembly instruction.

53. A podcast content aggregation, delivery and sharing method between a podcast unit and one or more client devices wherein the podcast unit periodically coupled to the client devices over a communications path, the method comprising:
gathering a plurality of podcast episodes;
managing the podcasts for users of the client devices based on a set of podcast preferences of each user;
determining whether to place accompany the podcast with an advertisement for a podcast destined for a particular client device based on a set of statistics associated with the client device; and
delivering the podcasts and the advertisements accompanying the podcast for the particular client device to the particular client device based on the set of podcast preferences of the particular user of the client device using the communications path.

54. The method of claim 53 further comprising playing, on a media player on each client device, the podcasts downloaded from the podcast unit.

55. The method of claim 54, wherein the media player is branded.

56. The method of claim 53 further comprising gathering on the client device podcast usage statistics for the client device.

57. The method of claim 56 further comprising periodically communicating the podcast usage statistics to the podcast unit.

58. The method of claim 57 further comprising rating a podcast based on the received podcast usage statistics.

59. The method of claim 53 further comprising matching a personalized advertisement to a podcast based on a set of user advertisement preferences.

60. The method of claim 53 further comprising mobilizing a podcast wherein a podcast on an affiliate site to be delivered to the client device of a user when the user engages the mobilize button on the affiliate site.

61. The method of claim 53 further comprising organizing the podcasts into one or more channels and wherein a podcast is organized into one or more channels.

62. The method of claim 54 further comprising bookmarking an advertisement contained in a podcast wherein the user can later view the bookmarked advertisement.

63. The method of claim 53 further comprising providing a mobile tip jar wherein a user of a client device can provide a monetary unit to a particular podcaster.

64. The method of claim 53 further comprising using an application service provider model for one or more affiliate sites coupled to the podcast unit.

65. The method of claim 53 further comprising generating an notification message using an SMS communication path to the podcast unit, selecting the content on the podcast unit using a WAP browser on the client device and downloading the selected content from the podcast unit over a WAP communication path.

66. The method of claim 53 further comprising determining a ratings of a particular podcast and providing feedback to a publisher of the particular podcast.

67. The method of claim 66, wherein determining the ratings further comprises generating an implicit rating for the particular podcast based on a listening pattern of a user to the particular podcast.

68. The method of claim 53 further comprises exchanging a token with the podcast unit to configure the client device.

69. The method of claim 53 further comprising communicating a token to each podcast publisher in order to validate the podcast.

70. The method of claim 53 further comprising converting incoming content into one or more formats for delivery to the client devices.

71. The method of claim 70, wherein the converting incoming content further comprises generating a plurality of podcast previews that can be downloaded to a client device.

72. The method of claim 53 further comprising publishing the podcasts to a website on a periodic basis.

73. The method of claim 53 further comprising managing, on each client device, the storage space of the content on the client device.

74. The method of claim 53 further comprising providing direct feedback to a publisher.

75. The method of claim 61 further comprising establishing a friends list having a group of users wherein a channel is shared between users in the friends list.

76. The method of claim 53, wherein managing the podcasts further comprises automatically downloading podcasts to a particular client device based on a set of content preferences of the user of the particular client device.

77. The method of claim 75, wherein managing the podcasts further comprises providing a user inbox wherein a user on the friends list places a podcast into the user inbox to share the podcast with the user.

78. The method of claim 53, wherein aggregating the podcasts further comprises receiving a piece of content wherein the piece of content has a disassembly instruction embedded in the piece of content and reorganizing the content based on the disassembly instruction.
